(19) United States
(12) Patent Application Publication
(10) Pub. No.: US 2026/0370345 A1
(43) Pub. Date: Nov. 19, 2026

(54) MULTI-POINT QUANTUM KEY DISTRIBUTION (QKD) LINK

(71) Applicant: MELLANOX TECHNOLOGIES, LTD., Yokneam (IL)

(72) Inventors: Ziv Abelson, Even Yehuda (IL); Tal Jhonathan Gofman, Haifa (IL); Ran Hasson Ruso, Pardes Hanna-Karkur (IL); Isabelle Cestier, Haifa (IL); Elad Mentovich, Tel Aviv (IL); Paraskevas Bakopoulos, Ilion (GR); Dimitrios Kalavrouziotis, Papagou (GR); Dimitrios Syrivelis, Volos (GR)

(21) Appl. No.: 19/220,540

(22) Filed: May 28, 2025

(30) Foreign Application Priority Data
May 19, 2025 (GR) 20250100378

(51) Int. Cl. H04B 10/70; H04B 10/25

(52) U.S. Cl. CPC H04B 10/70; H04B 10/2589

(57) ABSTRACT

Systems and methods include a quantum key distribution (QKD) link between a first connector and a second connector enabling a multipoint QKDs transmission between a first device connected to the first connector via a first link and a second device connected to the second connector via a second link.

### TECHNICAL FIELD

At least one embodiment is generally directed toward quantum key distribution (QKD) and, in particular, but not exclusively, toward a multi-point QKD link and methods of operating the same.

### BACKGROUND

Data centers play a pivotal role in storing, managing, and transmitting vast amounts of data critical to modern communication and computational infrastructure. As the demand for secure data transmission grows, QKD has emerged as a promising technology to enhance security by leveraging principles of quantum mechanics. QKD enables the generation and exchange of cryptographic keys that are inherently secure against eavesdropping, ensuring robust protection for sensitive information. Integrating QKD into data center operations may support secure communication across distributed systems and strengthen data center resilience against emerging cybersecurity threats.

### BRIEF DESCRIPTION OF THE SEVERAL VIEWS OF THE DRAWINGS

The present disclosure is described in conjunction with the appended figures, which are not necessarily drawn to scale:

FIG. 1 illustrates a conventional QKD network architecture showing interconnected devices and respective communication links;

FIG. 2 illustrates a QKD network architecture implementing systems and methods in accordance with at least one embodiment;

FIG. 3 illustrates a multipoint QKD transmission system in accordance with at least one embodiment;

FIG. 4 illustrates a QKD device with multiplexing capabilities in accordance with at least one embodiment;

FIG. 5 illustrates a QKD device with multiplexing capabilities in accordance with at least one embodiment;

FIG. 6 illustrates a QKD device incorporating demultiplexing capabilities in accordance with at least one embodiment;

FIG. 7 illustrates a QKD device incorporating both multiplexing and demultiplexing capabilities in accordance with at least one embodiment;

FIG. 8 illustrates a component-level architecture of a device, including both transmitter and receiver modules along with multiplexing and demultiplexing components in accordance with at least one embodiment;

FIG. 9 illustrates a network topology implementing QKD capabilities across multiple levels of network switches in accordance with at least one embodiment;

FIG. 10 illustrates an example data center, in accordance with at least one embodiment;

FIG. 11 illustrates a processing system, in accordance with at least one embodiment;

FIG. 12 illustrates a computer system, in accordance with at least one embodiment;

FIG. 13 illustrates an example bi-directional quantum interconnect with two (2) communication modules in accordance with one or more embodiments of the present disclosure;

FIG. 14 illustrates a system that facilitates QKD connectivity, in accordance with at least one embodiment;

FIG. 15 illustrates a system that facilitates QKD communication, in accordance with at least one embodiment;

FIG. 16 illustrates a computer system in accordance with at least one embodiment;

FIG. 17 illustrates a system including a NIC for facilitating communication within a network in accordance with at least one embodiment;

FIG. 18A illustrates a transceiver in accordance with at least one embodiment;

FIG. 18B illustrates a transceiver in accordance with at least one embodiment;

FIG. 19 illustrates optical transceiver scenarios in accordance with at least one embodiment;

FIG. 20 illustrates a computing system in accordance with at least one embodiment;

FIG. 21 illustrates a computing environment in accordance with at least one embodiment; and

FIG. 22 illustrates a computing system in accordance with at least one embodiment.

### DETAILED DESCRIPTION

QKD is a secure communication method that implements a cryptographic protocol involving components of quantum mechanics. QKD enables two devices to a mutually generate a QKD key known only to the two devices, which can be used to encrypt and decrypt messages. Conventionally, the two devices are required to be connected directly via an optical link. Any break in the connection, such as an intermediary device between the two connected devices, will prevent the establishment of a secure QKD link. As a result, conventional QKD technology requires every device communicating via QKD to be connected via a separate cable for each QKD link.

The disclosed systems and methods describe multipoint QKD links utilizing existing point-to-point QKD links infrastructure as relays which enable multiple QKD signals to be transmitted on a single cable, with each signal propagating in the cable at a particular wavelength. As used herein, a QKD link refers to a communication connection established between a first QKD device and a second QKD device for securely transmitting quantum states and generating shared secret keys. A multipoint QKD link as described herein enables a first device to securely transmit quantum states to a second device over a first optical signal carrier (e.g., an optical fiber) to a third device. The third device may be capable of receiving the quantum states from the first device and outputting the quantum states toward the second device without affecting the security of the quantum transmission. The third device may be capable of receiving quantum transmissions from a plurality of devices and routing the quantum transmissions toward a plurality of devices in a secure manner. The systems and methods described herein may be used with any QKD protocol, including, for example, BB84, decoy-state BB84, differential phase shift (DPS), or continuous-variable (CV-QKD) protocols. A sending device can send a first QKD signal toward a receiving device in an optical signal, the optical signal may pass through an intermediary device which may use a tunable demultiplexer (DEMUX) to extract a second QKD signal from the optical signal while allowing the rest of the optical signal to transmit from the intermediary device and toward the receiving device. The intermediary device may also include a wavelength multiplexer (MUX) (which multiplexes a number of optical carrier signals onto a single optical channel) enabling the intermediary device to add a QKD signal to the optical signal before the signal is sent toward the receiving device without affecting the first QKD signal.

The proposed techniques can be utilized to provide QKD links throughout a network (such as in a data center) without requiring excessive optical fiber connections directly connecting each of the devices. Instead, multiple QKD signals can piggyback on a single optical signal by using direct point-to-point links to reach nodes that have no direct connection between them. This drastically reduces the number of interconnections required in the network and leverages existing infrastructure while maintaining security.

As organizations increasingly rely on interconnected systems for communication, means of securing the transmission and storage of data from cyber threats, ranging from sophisticated hacking techniques to large-scale data breaches, are essential to protecting against unauthorized access, modification, or destruction of data, ensuring confidentiality, integrity, and availability. QKD provides an approach to securing communication channels, leveraging the principles of quantum mechanics to address limitations of traditional cryptographic methods. Unlike classical key exchange mechanisms, QKD enables the creation and exchange of cryptographic keys using quantum properties. QKD provides protection against potential quantum-based attacks. However, conventional QKD technology is expensive both in terms of money and energy and requires a large form factor.

Within data centers, which process, store, and transmit data, the need for advanced cybersecurity measures is critical. Data centers provide essential services ranging from cloud computing to financial transactions and healthcare operations, making the data stored within data centers attractive targets for cyberattacks. The volume and value of sensitive information handled in data centers necessitates robust security protocols to prevent breaches that could compromise data integrity or disrupt operations. Integrating QKD-based cyber security into data center environments provides a defense against potential threats. The systems and methods described herein may be used to fortify data centers with advanced cyber security, enabling an organization to ensure the resilience and reliability of its most critical digital assets.

Embodiments of the present disclosure include an apparatus, including: a first circuit to receive a first optical signal including at least a first one or more encoded photons; a QKD transmitter to generate a second optical signal including at least a second one or more encoded photons; a multiplexer circuit to multiplex the first optical signal with the second optical signal and to output a multiplexed optical signal including at least the first one or more encoded photons and the second one or more encoded photons; and a second circuit to transmit the multiplexed optical signal onto a fiber link including at least the first one or more encoded photons and the second one or more encoded photons.

Aspects of the apparatus include wherein the apparatus further includes a tunable de-multiplexer circuit to process the first optical signal and selectively output a third one or more encoded photons from the first optical signal; and a QKD receiver to receive the third one or more encoded photons.

Aspects of the apparatus include wherein the tunable de-multiplexer circuit chromatically separates a third optical signal from the first optical signal based on a wavelength of the third optical signal, wherein the third optical signal includes a third one or more encoded photons.

Aspects of the apparatus include wherein the first optical signal includes the first one or more encoded photons at a first wavelength and a third one or more encoded photons at a second wavelength.

Aspects of the apparatus include wherein the multiplexer circuit is tunable and multiplexes a plurality of optical signals of different wavelengths with the first optical signal.

Aspects of the apparatus include wherein the QKD transmitter generates a plurality of sets of one or more encoded photons and outputs each set of one or more encoded photons at a different wavelength.

Aspects of the apparatus include wherein the apparatus forms a uni-directional QKD link.

Aspects of the apparatus include wherein the apparatus forms a bi-directional QKD link.

Aspects of the apparatus include wherein the first circuit and the second circuit each comprise a fiber connection circuit.

Aspects of the apparatus include wherein the apparatus is one of a mid-board optical module (MBOM), a linear pluggable optics (LPO) transceiver, a quad small form-factor pluggable (QSFP) transceiver, a quad small form-factor pluggable double density (QSFP-DD) transceiver.

Aspects of the apparatus include wherein the apparatus is an optical switch.

Aspects of the apparatus include wherein the first circuit, the QKD transmitter, the multiplexer circuit, and the second circuit are contained within a co-packaged optics (CPO) package.

Aspects of the apparatus include wherein the apparatus further comprises optical and electronic components integrated in an integrated circuit.

Aspects of the apparatus include wherein the first and second circuits each comprise a dedicated fiber link.

Aspects of the apparatus include wherein the apparatus establishes a QKD link between the apparatus and a plurality of nodes.

Aspects of the apparatus include wherein the apparatus establishes a QKD link between a first plurality of nodes and a second plurality of nodes.

Aspects of the apparatus include wherein the first one or more encoded photons are received from a first device via a first optical fiber link and are transmitted to a second device via a second optical fiber link, wherein the first device and the second device establish a QKD link using the one or more encoded photons.

Aspects of the apparatus include wherein the second one or more encoded photons are transmitted to the second device via a second optical fiber link, wherein the apparatus and a third device establish a QKD link using the one or more encoded photons.

Embodiments also include an apparatus, including: a first circuit to receive a first optical signal including at least a first one or more encoded photons and a second one or more encoded photons; a tunable de-multiplexer circuit to process the first optical signal and selectively output the first one or more encoded photons from the first optical signal; a QKD receiver to receive the first one or more encoded photons; and a second circuit to transmit a second optical signal including at least the second one or more encoded photons.

Aspects of the apparatus include wherein the apparatus further includes a QKD transmitter to generate a third optical signal including a third one or more encoded photons and a multiplexer circuit to multiplex the third optical signal including the third one or more encoded photons with an optical signal output by the de-multiplexer circuit comprising the second one or more encoded photons and to output the second optical signal including at least the second one or more encoded photons and the third one or more encoded photons.

Aspects of the apparatus include wherein the multiplexer circuit is tunable and multiplexes a plurality of optical signals of different wavelengths with the third optical signal.

Aspects of the apparatus include wherein the QKD transmitter generates a plurality of quantum signals and outputs each quantum signal at a different wavelength.

Aspects of the apparatus include wherein the tunable de-multiplexer circuit chromatically separates a third optical signal from the first optical signal based on a wavelength of the third optical signal, wherein the third optical signal includes a third one or more encoded photons.

Aspects of the apparatus include wherein the second optical signal includes the first one or more encoded photons at a first wavelength and a third one or more encoded photons at a second wavelength.

Aspects of the apparatus include wherein the apparatus forms a uni-directional QKD link.

Aspects of the apparatus include wherein the apparatus forms a bi-directional QKD link.

Aspects of the apparatus include wherein the first circuit and the second circuit each comprise a fiber connection circuit.

Aspects of the apparatus include wherein the apparatus is one of a mid-board optical module (MBOM), a linear pluggable optics (LPO) transceiver, a quad small form-factor pluggable (QSFP) transceiver, a quad small form-factor pluggable double density (QSFP-DD) transceiver.

Aspects of the apparatus include wherein the apparatus is an optical switch.

Aspects of the apparatus include wherein the first circuit, the QKD receiver, the de-multiplexer circuit, and the second circuit are contained within a co-packaged optics (CPO) package.

Aspects of the apparatus include wherein the apparatus further comprises optical and electronic components integrated in an integrated circuit.

Aspects of the apparatus include wherein the first and second circuits each comprise a dedicated fiber link.

Embodiments also include a transceiver, including: a first circuit to receive a first optical signal including at least a first quantum transmission; a QKD transmitter to generate a second quantum transmission and output a second optical signal; a multiplexer circuit to multiplex the first optical signal including the first quantum transmission with the second optical signal comprising the second quantum transmission and to output a multiplexed optical signal including at least the first quantum transmission and the second quantum transmission; and a second circuit to transmit the multiplexed optical signal including at least the first quantum transmission and the second quantum transmission.

Aspects of the apparatus include wherein the transceiver further includes: a tunable de-multiplexer circuit to process the first optical signal and selectively output a third quantum transmission from the first optical signal; and a QKD receiver to receive the third quantum transmission.

Aspects of the apparatus include wherein the tunable de-multiplexer circuit chromatically separates a third optical signal from the first optical signal based on a wavelength of the third optical signal, wherein the third optical signal includes the third quantum transmission.

Aspects of the apparatus include wherein the first optical signal carries a plurality of quantum transmissions.

Aspects of the apparatus include wherein the multiplexer circuit is tunable and multiplexes a plurality of optical signals of different wavelengths with the first optical signal.

Aspects of the apparatus include wherein the QKD transmitter generates a plurality of quantum transmissions and outputs each quantum transmission at a different wavelength.

Aspects of the apparatus include wherein the transceiver forms a uni-directional QKD link.

Aspects of the apparatus include wherein the transceiver forms a bi-directional QKD link.

Aspects of the apparatus include wherein the first circuit and the second circuit each comprise a fiber connection circuit.

Embodiments also include a QKD device, including: a first circuit to receive a first optical signal including at least a first quantum transmission; a QKD transmitter to generate a second quantum transmission and output a second optical signal; a multiplexer circuit to multiplex the first optical signal including the first quantum transmission with the second optical signal comprising the second quantum transmission and to output a multiplexed optical signal including at least the first quantum transmission and the second quantum transmission; and a second circuit to transmit the multiplexed optical signal including at least the first quantum transmission and the second quantum transmission.

Embodiments also include a data center, including: a plurality of nodes; an optical communication channel providing data communication between the plurality of nodes; and a QKD circuit, including: a first circuit to receive a first optical signal including at least a first quantum transmission; a QKD transmitter to generate a second quantum transmission and output a second optical signal; a multiplexer circuit to multiplex the first optical signal including the first quantum transmission with the second optical signal comprising the second quantum transmission and to output a multiplexed optical signal including at least the first quantum transmission and the second quantum transmission; and a second circuit to transmit the multiplexed optical signal including at least the first quantum transmission and the second quantum transmission.

Embodiments also include an apparatus, including: a first circuit to receive a first optical signal including at least a first quantum transmission; a second circuit to receive a second optical signal including at least a second quantum transmission; a multiplexer circuit to multiplex the first optical signal including the first quantum transmission with the second optical signal comprising the second quantum transmission and to output a multiplexed optical signal including at least the first quantum transmission and the second quantum transmission; and a third circuit to transmit the multiplexed optical signal including at least the first quantum transmission and the second quantum transmission.

Embodiments also include an apparatus, including: a first circuit to receive a first optical signal including at least a first quantum transmission and a second quantum transmission; a tunable de-multiplexer circuit to process the first optical signal and selectively output the first quantum transmission from the first optical signal; a second circuit to transmit a second optical signal including at least the first quantum transmission; and a second circuit to transmit a third optical signal including at least the second quantum transmission.

Embodiments also include an apparatus, comprising a QKD link between a first connector and a second connector enabling a multipoint QKDs transmission between a first device connected to the first connector via a first link and a second device connected to the second connector via a second link.

Embodiments also include an apparatus, comprising a multipoint QKD link, the apparatus configured to provide a QKD communication channel between two devices, wherein each device is connected to the apparatus via a respective link.

A quantum communication channel as described herein may refer to a line (e.g., an optical fiber, a quantum line, trace, wire, cable, and/or free space) over which quantum data or information and particles, such as qubits, are exchanged using one or more quantum cryptographic techniques that rely on these quantum properties. Cables (such as the optical cables described below) and connectors as described herein may be designed to comply with any applicable standard, for example Ethernet and InfiniBand standards, such as Ethernet variants 200GBASE-FR4, 400GBASE-FR4, and 100GBASE-LR4 to support four wavelengths.

One aspect of the present disclosure is to provide a level of integration of QKD functionality in co-packaged datacenter switches or similar networking devices. Several different architectures are proposed, enabling different partitioning of functionalities.

Co-packaging may refer to the close integration of different electrical and/or optoelectronic chips in the same package. The different chips that constitute the co-packaged system are assembled on a single substrate in what is typically called a multi-chip module (MCM) assembly. The MCM assembly can include switching circuitry surrounded by peripheral chips, which may also be referred to as satellite chips or chiplets. In some embodiments, the switching circuitry and chiplets are all mounted on a common substrate, although such a configuration is not required. The MCM assembly may be provided in a larger housing of the networking device, positioned behind the front panel and transceiver ports exposed at the front panel. The switching circuitry may include one or more core digital Application Specific Integrated Circuits (ASICs), CPUs, GPUs, microprocessors, FPGAs, combinations thereof, and the like.

In the context of high-throughput switches and optoelectronics, co-packaging allows transferring the optoelectronic transceivers from the front panel (where they are currently deployed in the form of pluggable modules) to the MCM chiplets inside the enclosure of the networking device. The fiber optical I/Os from the chiplets are transferred to the front panel where compact optical connectors now reside, replacing the bulky pluggable ports. This saves front panel area which can be used to accommodate integration of a QKD system.

In an illustrative embodiment, a switch includes an MCM assembly, where the MCM assembly includes: switching circuitry; an encryption unit that is configured to encrypt and/or decrypt communications processed by the switching circuitry; and a controller coupled with the MCM assembly and configured to provide interconnectivity between the MCM assembly and a QKD device.

Thus, to address these and/or other issues, a network interface controller for quantum computing over classical and quantum communication channels is disclosed herein. For instance, the system architecture disclosed herein facilitates deployment of QKD technology in a datacenter network. As such, by employing the QKD technology, datacenter connections can be provided with technological benefits such as, for example, improved security (e.g., to provide information-theoretic security for a datacenter network, etc.), improved performance, improved efficiency, reduced processing load for a datacenter system, and/or one or more other technological benefits. In one or more embodiments, an embedded processor within a network interface controller is employed to perform quantum processing (e.g., processing of one or more quantum algorithms). The embedded processor can be, for example, a system on chip (SoC), an FPGA, a GPU, a CPU, or another type of processor. In one or more embodiments, quantum processing includes converting qubits received via a quantum communication link into binary bits. Therefore, instead of employing a dedicated ASIC (e.g., a DSP processor of a coherent processor) to conduct quantum processing, a network interface controller can employ an embedded processor within the network interface controller to conduct quantum processing. Furthermore, by employing an embedded processor within a network interface controller to conduct quantum processing, an interface between QKD-based communications and non-QKD-based communications can be provided. Accordingly, improved utilization of QKD-based communication within datacenters and/or HPC clusters can be provided. For example, in certain implementations a quantum computer can operate within a quantum framework and can also access external resources (e.g., memory blocks) configured for binary-based communications. Moreover, as compared to conventional datacenter networks, embodiments disclosed herein provide for improved security for a datacenter network, improved performance for a datacenter network, and/or improved efficiency for a datacenter network.

The present description provides embodiments only, and is not intended to limit the scope, applicability, or configuration of the claims. Rather, the description will provide those skilled in the art with an enabling description for implementing the described embodiments. It is understood that various changes may be made in the function and arrangement of elements without departing from the spirit and scope of the appended claims.

It will be appreciated from the following description, and for reasons of computational efficiency, that the components of the system can be arranged at any appropriate location within a distributed network of components without impacting the operation of the system.

Furthermore, it should be appreciated that the various links connecting the elements can be wired, traces, or wireless links, or any appropriate combination thereof, or any other appropriate known or later developed element(s) that is capable of supplying and/or communicating data to and from the connected elements. Transmission media used as links, for example, can be any appropriate carrier for electrical signals, including coaxial cables, copper wire and fiber optics, electrical traces on a printed circuit board (PCB), or the like.

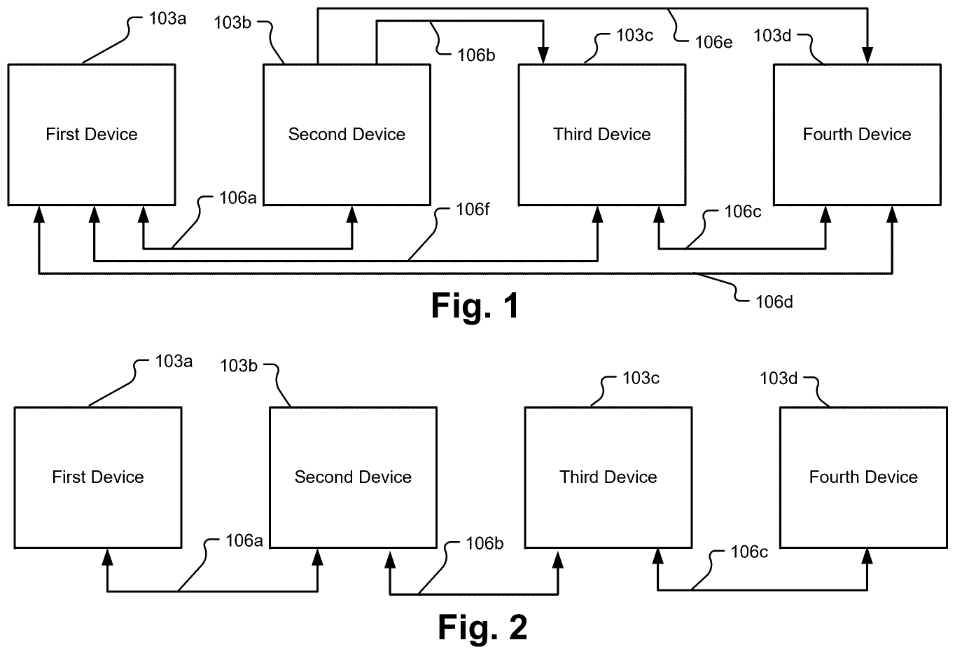

Referring now to FIGS. 1-22, various systems and methods for a QKD device will be described.

As illustrated in FIG. 1, a conventional arrangement of QKD devices is shown. The system comprises a plurality of devices 103a, 103b, 103c, and 103d interconnected through multiple QKD links 106a-106f. In the depicted embodiment, each device 103a-103d incorporates quantum communication capabilities necessary for establishing secure cryptographic key exchange with other devices in the network.

FIG. 1 demonstrates the conventional approach wherein each device (e.g. nodes) 103a-103d requires a direct and dedicated QKD link with any other device with which secure communication is desired. For example, a first device 103a establishes direct QKD links 106a, 106f, and 106d with second, third, and fourth devices 103b, 103c, and 103d, respectively. Similarly, the second device 103b maintains direct QKD links 106a, 106b, and 106e with the first, third, and fourth devices 103a, 103c, and 103d, respectively. The third device 103c connects via direct QKD links 106f, 106b, and 106c to the first, second, and fourth devices 103a, 103b, and 103d, respectively. Finally, the fourth device 103d establishes connections through direct QKD links 106d, 106e, and 106c with the first, second, and third devices 103a, 103b, and 103c, respectively.

The configuration illustrated in FIG. 1 highlights a fundamental limitation of conventional QKD implementations. Specifically, to enable complete connectivity wherein each device 103a-103d can securely communicate with any other device in the network, a total of six separate QKD links 106a-106f are required. This requirement stems from the conventional constraint that secure quantum key exchange necessitates a direct optical path between communicating parties. As evident from FIG. 1, the number of required QKD links increases quadratically with the number of devices, following the formula n(n−1)/2, where n represents the number of devices in the network. This quadratic scaling presents significant challenges to the scalability and cost-effectiveness of conventional QKD networks, particularly as the number of participating devices increases.

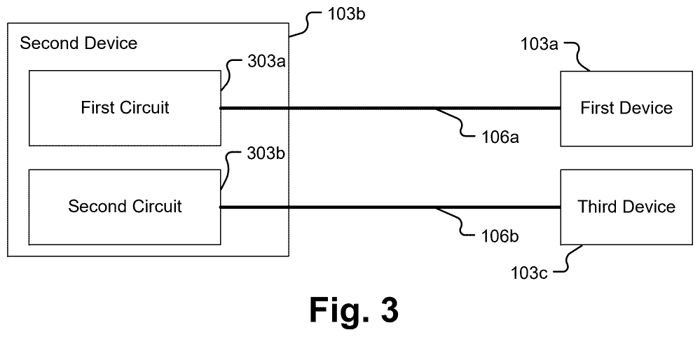

Referring now to FIG. 2, an arrangement of QKD devices 103a-d is depicted that may be used to implement systems and methods of the present disclosure. As illustrated in FIG. 2, a plurality of devices 103a-103d are interconnected through a reduced number of QKD links 106a-106c as compared to the arrangement of FIG. 1 as described above. In the implementation illustrated in FIG. 2, each device 103a-103d is enabled to securely communicate with any of the other devices 103a-103d using only a single shared QKD direct link 106a-106c between adjacent devices, resulting in a total of three separate QKD links 106a-106c to provide secure QKD communication between any of the four devices 103a-103d.

In order to realize this arrangement, in various implementations of the present disclosure, at least some of the devices 103a-103d may include both transmission (TX) and receiving (RX) capabilities, while in some implementations some devices 103a-d may include either TX or RX capabilities. As should be appreciated by those skilled in the art, there is considerable flexibility in the implementation of this arrangement, and the systems and methods described herein enable a few TX to many RX approach and/or a few RX to many TX approach which may advantageously simplify the design and reduce component costs.

In support of these capabilities, each device 103a-103d may be equipped with the functionality to alter the operating wavelength in both the transmitter and the receiver components. This wavelength tunability can be achieved through the implementation of a tunable chromatic filter integrated on the TX and RX ports of the device 103a-103d, allowing for dynamic wavelength selection to establish secure communication paths across the network.

In various embodiments, a device 103 as described herein may comprise a QKD module or circuit capable of providing QKD capabilities for computing systems such as network interface controllers (NICs), switches, routers, and/or any system capable of sending and receiving data. The device 103, which may alternatively be referred to as an apparatus, may be configured to perform various functions and may be implemented in several forms.

In some embodiments, the device 103 may be configured to form a uni-directional QKD link, wherein the device functions as a transceiver. In other embodiments, the device 103 may be configured to form a bi-directional QKD link, wherein the device similarly functions as a transceiver with bidirectional capabilities.

The physical implementation of device 103 may vary according to application requirements. In various embodiments, the device 103 may be one of a mid-board optical module (MBOM), a linear pluggable optics (LPO) transceiver, a quad small form-factor pluggable (QSFP) transceiver, or a quad small form-factor pluggable double density (QSFP-DD) transceiver. In other embodiments, the device 103 may be implemented as an optical switch to facilitate dynamic routing of quantum signals.

In yet other embodiments, the device 103 may be implemented as a co-packaged optics (CPO) package, wherein the elements of the device 103 may be contained within the CPO package to achieve higher integration density. Alternatively, or additionally, the device 103 may be implemented as an integrated circuit (IC) that includes optical and electronic components integrated within the IC.

In some embodiments, the device 103 may include a first circuit and a second circuit, where the first and second circuit each comprise a fiber connection circuit to facilitate optical interconnection with other devices. Additionally, the device 103 may be configured to establish a QKD link between itself and a plurality of other devices 103. In further embodiments, the device 103 may be used to establish a QKD link between a first plurality of devices 103 and a second plurality of devices 103, enabling group-to-group secure quantum communication.

This configuration of FIG. 2 represents an advancement over the conventional arrangement shown in FIG. 1, as it reduces the number of required QKD links from n(n−1)/2 to n−1, where n represents the number of devices (e.g., from six to three for full connectivity among four devices), thereby demonstrating enhanced scalability and cost-effectiveness of the disclosed QKD network architecture.

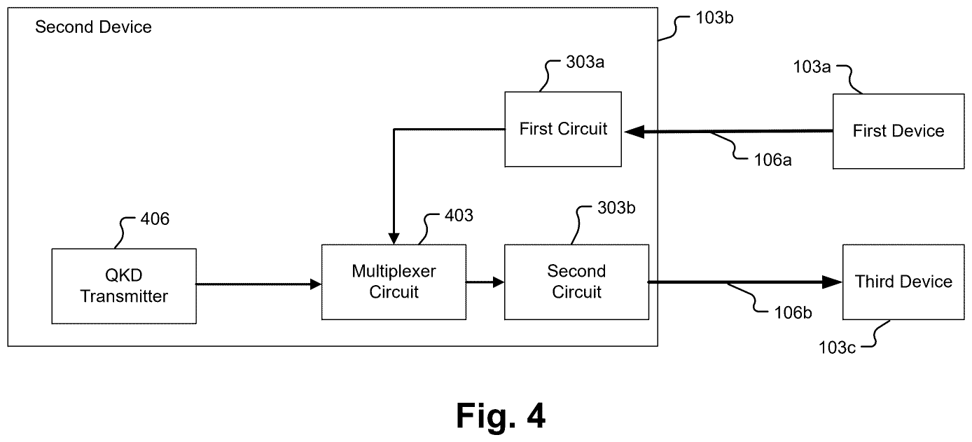

Referring to FIG. 3, a multipoint QKD system is illustrated in accordance with embodiments of the present disclosure. As shown in FIG. 3, a first device 103a is enabled to communicate with a third device 103c via a second device 103b that functions as an intermediary node.

In the depicted embodiment, the first device 103a transmits a quantum transmission over a first link 106a to a first circuit 303a of the second device 103b. Upon receiving this quantum transmission, the second device 103b subsequently transmits the quantum transmission received from the first device 103a over a second link 106b toward the third device 103c using a second circuit 303b. In various implementations, the first circuit 303a and the second circuit 303b may each comprise optical connectors configured to interface with their respective optical links.

Through this arrangement, the second device 103b may operate as a QKD link between a first connector and a second connector, thereby enabling a multipoint QKD transmission between the first device 103a connected to the first circuit 303a via the first link 106a and the third device 103c connected to the second circuit 303b via the second link 106b. In this manner, the second device 103b may serve as a multipoint QKD link and be configured to provide a QKD communication channel between the first and third devices 103a, 103c, where the first and third devices 103a, 103c are each connected to the second device 103b via a respective link 106a, 106b.

The first circuit 303a may be configured to receive a first optical signal over the first link 106a. In various embodiments, the first optical signal includes at least a first one or more encoded photons that carry quantum information necessary for establishing secure cryptographic keys. The first one or more encoded photons may be received from the first device 103a via the first link 106a and subsequently transmitted to the third device 103c via the second link 106b. Through this transmission of encoded photons, the first device 103a and the third device 103c may establish a secure QKD link without requiring a direct physical connection between them.

In some embodiments, the first and second links 106a, 106b comprise optical fiber links, and the first and second circuits 303a, 303b are configured to operate as dedicated fiber link interfaces. These fiber links may provide a transmission medium for the quantum signals while maintaining quantum coherence and security properties for QKD protocols.

Each of the first and second circuits 303a, 303b may be capable of transmitting and/or receiving a multiplexed optical signal via a fiber link. In some implementations, the first and second circuits 303a, 303b may each transmit an optical signal at a specific wavelength for a respective QKD link. The two optical signals, each at a specific wavelength, may be multiplexed together into a multiplexed optical signal. The multiplexed optical signal may be received at a receiving device which may separate the multiplexed optical signal into two optical signals, one at the specific wavelength transmitted from the first circuit 303a and one at the specific wavelength transmitted from the second circuit 303b. A multiplexed optical signal may advantageously include two or more sets of encoded photons, with each set of encoded photons being transmitted at a particular wavelength. As described in greater detail below in the disclosure, each set of encoded photons may be utilized to establish a secure QKD link between different devices 103, thereby enabling simultaneous multiple secure connections through wavelength division multiplexing techniques.

The systems and methods described herein provide a number of configuration options for devices participating in the QKD network. A device could be selectively configured to be capable of adding quantum transmissions (e.g., encoded photons) to a signal, removing quantum transmissions from a signal, or capable of both adding and removing quantum transmissions from the signal.

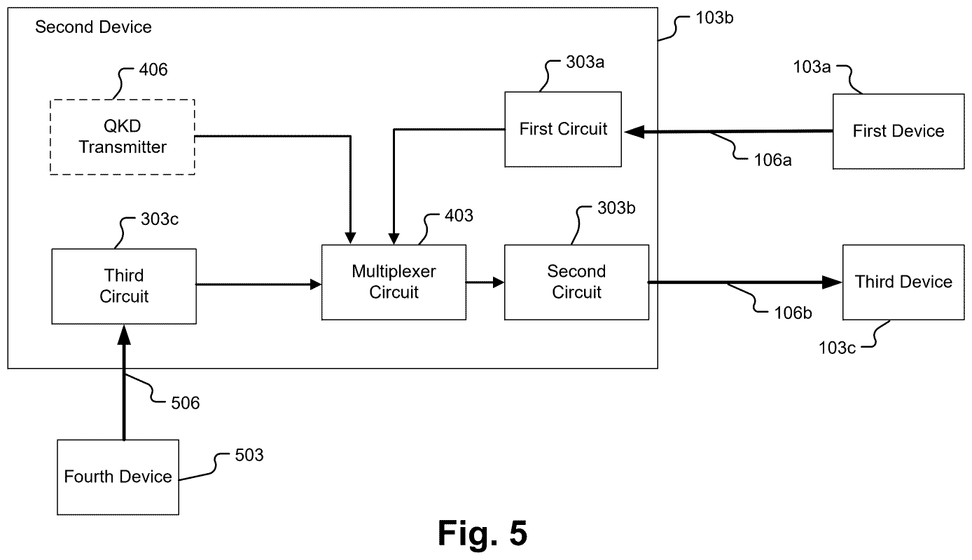

Referring now to FIG. 4, a device 103 (e.g., the second device 103b referenced above) is shown comprising multiplexing functionality in accordance with embodiments of the present disclosure. As illustrated in FIG. 4, the device 103 may include a MUX circuit 403 configured to combine multiple quantum signals into a single transmission path.

As described herein, a MUX circuit 403 may serve as an optical component configured to combine multiple optical signals of different wavelengths into a single multiplexed optical signal. A MUX circuit 403 may function by accepting multiple independent optical inputs, each potentially carrying distinct quantum information, and combining them into a composite output signal for transmission over a shared optical path. A MUX circuit 403 as described herein may be tunable, potentially allowing for dynamic adjustment of which wavelength channels are combined and how they are processed. For example, a MUX circuit 403 may combine quantum signals from multiple sources, potentially including locally generated quantum transmissions and pass-through quantum transmissions from other network nodes.

In the depicted embodiment, the MUX circuit 403 is configured to multiplex a first optical signal including a first one or more encoded photons with a second optical signal including a second one or more encoded photons and output a multiplexed optical signal including at least the first one or more encoded photons and the second one or more encoded photons.

In various implementations, the MUX circuit 403 may be tunable, and configured to multiplex a plurality of optical signals of different wavelengths with a first optical signal. This tunability feature provides the flexibility to dynamically allocate quantum channels across the available optical spectrum.

As should be appreciated by those skilled in the art, each optical signal input into the MUX circuit 403 may carry any number of one or more QKD transmissions, with each QKD transmission including one or more encoded photons at a particular wavelength. This wavelength division approach enables multiple independent QKD connections to be established simultaneously through the same physical infrastructure.

The device 103 may further include a QKD transmitter 406 as illustrated in FIG. 4. The QKD transmitter 406 is configured to generate an optical signal including one or more encoded photons. Specifically, the QKD transmitter 406 may be configured to output the encoded photons with quantum states prepared according to the requirements of an implemented QKD protocol. In some implementations, the QKD transmitter 406 may be additionally configured to generate a plurality of sets of one or more encoded photons and output each set of one or more encoded photons at a different wavelength, thereby providing native wavelength diversity for multiple parallel QKD channels.

As illustrated in FIG. 4, the quantum key distribution system enables multi-stage transmission of quantum signals across multiple devices. In the depicted implementation, a first device 103a transmits a first optical signal including a first set of one or more encoded photons at a first wavelength over a first link 106a to a first circuit 303a of the second device 103b. Concurrently, the QKD transmitter 406 of the second device 103b may generate and transmit a second optical signal including a second set of one or more encoded photons at a second wavelength distinct from the first wavelength.

Within the second device 103b, both the first optical signal including the first set of encoded photons (received from the first device 103a) and the second optical signal including the second set of encoded photons (generated by the QKD transmitter 406) may be directed to the MUX circuit 403. The MUX circuit 403 may perform a chromatic multiplexing to combine the first optical signal including the first set of encoded photons and the second optical signal including the second set of encoded photons into a single multiplexed optical signal. This multiplexed optical signal, including both the first and second sets of encoded photons at their respective wavelengths, may subsequently be output from the second device 103b by the second circuit 303b onto a second link 106b for transmission toward a third device 103c.

Upon receiving the multiplexed optical signal, the third device 103c may be enabled to initiate a QKD communication link with either or both of the first device 103a and the second device 103b. This capability stems from the third device 103c's ability to selectively process the different wavelength components of the multiplexed signal, thereby extracting the quantum information encoded in either the first set of encoded photons (originating from the first device 103a) or the second set of encoded photons (originating from the second device 103b), or both.

Furthermore, in some embodiments, the third device 103c may also or alternatively pass one or both of the first and second sets of encoded photons on to a fourth device (not shown in FIG. 4). This relay capability enables the first device 103a or second device 103b to establish a secure QKD communication link with the fourth device without requiring a direct physical connection. This multi-hop quantum signal routing represents a significant advancement in QKD network topology flexibility, enabling secure quantum communication across extended distances and complex network architectures.

Through this arrangement, a system such as depicted in FIG. 4 may enable multiple quantum channels to be efficiently managed, combined, and routed through a QKD network infrastructure, enabling secure communication between multiple devices with minimal physical link requirements.

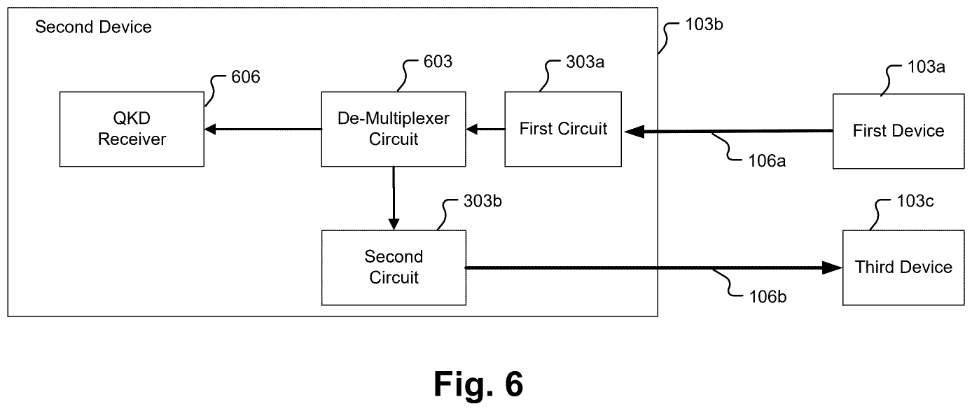

Referring now to FIG. 5, an alternative embodiment of a device 103 (for example, the second device 103b) is illustrated in accordance with the present disclosure. As shown in FIG. 5, the second device 103b may be configured to function as a quantum signal multiplexing and routing node without necessarily incorporating its own QKD transmitter 406.

In the depicted embodiment, the MUX circuit 403 of the second device 103b is capable of multiplexing quantum transmissions received from multiple devices (for example, the first device 103a and a fourth device 503 illustrated in FIG. 5) over multiple links (a link 106a between the first device 103a and the first circuit 303a, and a link 506 between the fourth device 503 and a third circuit 303c). The MUX circuit 403 may process the multiple input quantum signals and output a multiplexed quantum transmission as a composite optical signal over a link 106b toward a third device 103c.

The second device 103b of FIG. 5 is similar in architecture to the second device 103b previously described in relation to FIG. 4, with the addition of a third circuit 303c. This third circuit 303c may be configured to receive an optical signal including a third set of encoded photons transmitted from a fourth device 503 over a link 506. In this expanded configuration, the MUX circuit 403 may be configured to combine the optical signals from both the first device 103a and the fourth device 503, and optionally an optical signal from the QKD transmitter 406, and to output the resulting multiplexed optical signal toward the third device 103c via the second circuit 303b and link 106b.

In operation, the first device 103a may transmit a first set of one or more encoded photons at a first wavelength over the first link 106a to the first circuit 303a of the second device 103b. Concurrently, the fourth device 503 may transmit a third set of one or more encoded photons at a second wavelength over the link 506 to the third circuit 303c of the second device 103b. In some implementations, the first wavelength and the second wavelength may be distinct to enable proper separation and processing of the respective quantum signals. In some implementations, the MUX circuit 403 may be enabled to handle signals received at the same or similar wavelengths and to adjust the wavelengths of one or more of the received signals such that the signals can be chromatically multiplexed.

Upon receiving the distinct quantum signals, the MUX circuit 403 may perform a wavelength division multiplexing operation to combine the first set of encoded photons and the third set of encoded photons into a single multiplexed optical signal. This multiplexed optical signal, now containing quantum information from both the first device 103a and the fourth device 503, and optionally quantum information from the QKD transmitter 406, may be transmitted from the second circuit 303b of the second device 103b over the second link 106b to the third device 103c.

The third device 103c, upon receiving the multiplexed optical signal from the second device 103b, may be equipped with wavelength demultiplexing capabilities to separate the individual quantum channels. This separation enables the third device 103c to selectively establish secure QKD links with either or both of the first device 103a and the fourth device 503 based on the respective encoded photons contained within the multiplexed signal.

Additionally, in some embodiments, the third device 103c may be configured to relay one or both sets of encoded photons to additional devices in the network. For example, the third device 103c might forward the first set of encoded photons (originating from the first device 103a) to a fifth device (not shown in FIG. 5) to enable the establishment of a secure QKD link between the first device 103a and this fifth device without requiring a direct physical connection between them. Similarly, the third device 103c might forward the third set of encoded photons (originating from the fourth device 503) to other network nodes.

This architecture, as illustrated in FIG. 5, demonstrates an advancement in QKD network design by enabling routing and multiplexing of quantum signals from multiple sources without requiring every node to have direct connections with every other node. This approach substantially reduces the number of physical links required to establish secure quantum communication channels between multiple devices in a network, thereby enhancing scalability and reducing deployment costs.

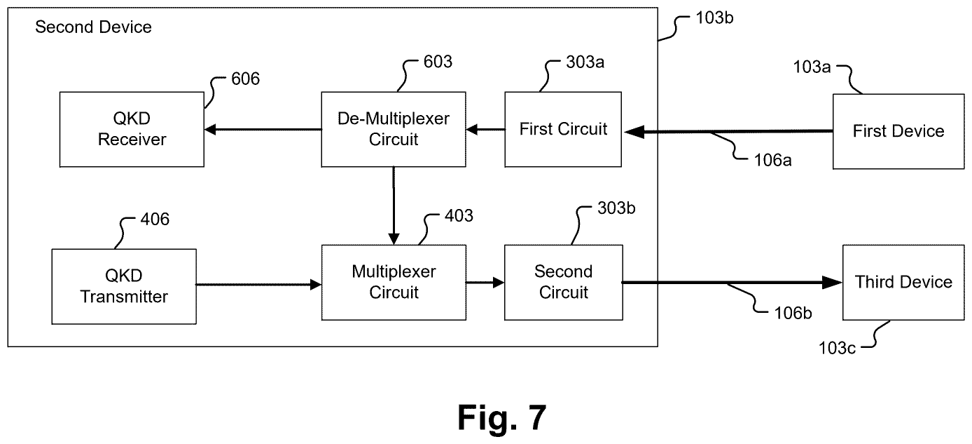

Referring now to FIG. 6, an embodiment of a device 103 (for example, the second device 103b) is illustrated that implements selective quantum signal extraction capabilities in accordance with the present disclosure. As illustrated in FIG. 6, the second device 103b includes a DEMUX circuit 603 configured to separate specific wavelength components from multiplexed optical signals.

As described herein, a DEMUX circuit 603 may function as an optical component that chromatically separates multiplexed optical signals based on their wavelengths. A DEMUX circuit 603 may operate by receiving a composite (e.g., multiplexed) optical signal containing multiple wavelength components and selectively extracting specific wavelength channels from this signal. The DEMUX circuit 603 may be tunable, allowing it to potentially be adjusted either manually or automatically to selectively extract different wavelength components as needed.

The tunable DEMUX may for example selectively extract quantum channels encoded at specific wavelengths from a multiplexed optical signal, potentially directing these channels to appropriate QKD receivers while allowing other wavelength components to pass through for transmission to other network nodes.

In the depicted embodiment, the DEMUX circuit 603 may comprise a tunable DEMUX configured to process a first optical signal and selectively output one or more optical signals, each at a particular wavelength. The tunability aspect of the DEMUX circuit 603 may enable the device 103b to selectively receive and/or forward different quantum channels.

As an example of operation, a first multiplexed optical signal received by the second device 103b at a first circuit 303a over a first link 106a from a first device 103a may include a first one or more encoded photons at a first wavelength and a second one or more encoded photons at a second wavelength. In processing this multiplexed optical signal, the tunable DEMUX circuit 603 may chromatically separate the first multiplexed optical signal into a second optical signal and a third optical signal, wherein the second optical signal includes the first one or more encoded photons and the third optical signal includes the second one or more encoded photons. This wavelength-selective separation enables the device to extract specific quantum channels from a multiplexed transmission.

The second device 103b may include a QKD receiver 606 as illustrated in FIG. 6. The QKD receiver 606 may be specifically configured to receive one or more encoded photons from the DEMUX circuit 603 and to perform quantum measurements on these photons in accordance with the implemented QKD protocol. Such measurements may enable the extraction of secure cryptographic key material from the quantum states encoded in the received photons.

In operation, the second device 103b may receive a first optical signal from a first device 103a via a first link 106a at a first circuit 303a as described above. The first optical signal may include any number of one or more optical signals which may be multiplexed and at particular wavelengths, each potentially carrying distinct quantum information for different secure communication channels.

Upon receipt of this multiplexed signal, the first circuit 303a may output the received first optical signal to the DEMUX circuit 603, which performs a chromatic separation operation to isolate a particular wavelength from the first optical signal. This separation may be performed based on specific wavelength characteristics of the component signals within the multiplexed transmission.

The DEMUX circuit 603 may be specifically tuned to output a particular wavelength towards the QKD receiver 606 while allowing the rest of the first optical signal to be output from the second device 103b by a second circuit 303b to a third device 103c via the second link 106b. This selective processing capability may enable the second device 103b to simultaneously participate in a secure QKD communication with the first device 103a and/or other devices while also or alternatively relaying other quantum channels to additional devices in the network.

This architecture as illustrated in FIG. 6 enables the creation of complex QKD network topologies where devices can selectively participate in multiple simultaneous secure communications while also or alternatively functioning as routing nodes for quantum signals destined for other network participants. The combined multiplexing and demultiplexing capabilities described in FIGS. 4, 5, and 6 provide the foundation for flexible and efficient quantum networks that maximize secure connectivity while minimizing the required physical infrastructure.

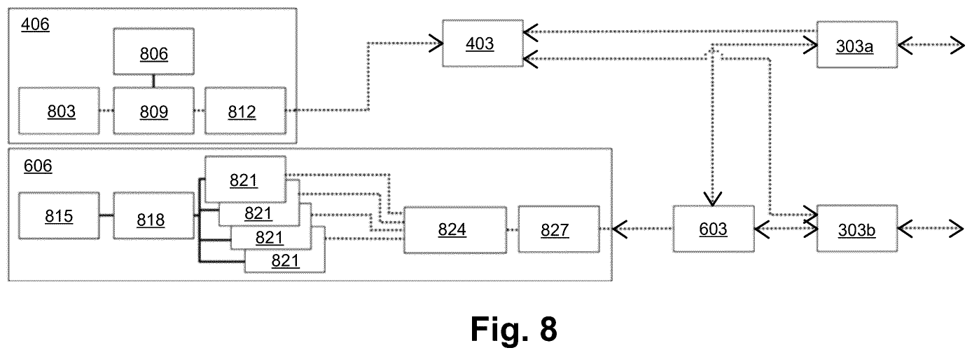

Referring now to FIG. 7, an embodiment of a device 103 (specifically, the second device 103b) is illustrated that implements a comprehensive quantum signal processing architecture in accordance with the present disclosure. As illustrated in FIG. 7, the second device 103b incorporates both a DEMUX circuit 603 and a MUX circuit 403, enabling bidirectional quantum signal processing capabilities within a single device.

In the depicted embodiment, the second device 103b receives an optical signal from a first device 103a via a first link 106a at a first circuit 303a. This received optical signal may contain a plurality of optical signals multiplexed at various wavelengths, each potentially carrying distinct quantum information encoded as quantum states of individual photons. Upon receipt of this multiplexed signal, the first circuit 303a directs the incoming optical signal to the DEMUX circuit 603 for processing.

The DEMUX circuit 603 performs wavelength-selective separation of the received optical signal components. Specifically, the DEMUX circuit 603 may be tuned to output an optical signal at a first wavelength to a QKD receiver 606 of the second device 103b while simultaneously directing the remaining wavelength components of the received optical signal to the MUX circuit 403. This selective extraction enables the second device 103b to participate in a secure QKD session using the specifically extracted quantum channel while continuing to route other quantum channels to additional destinations.

The QKD receiver 606 performs quantum measurements on the received encoded photons in accordance with the implemented QKD protocol. These measurements may include detection of photon polarization states, phase states, time-bin encoding, or other quantum properties depending on the specific QKD protocol implementation. The measurement results obtained by the QKD receiver 606 are then processed by computational components (not explicitly shown in FIG. 7) to derive secure cryptographic key material for securing subsequent classical communications.

Concurrent with the processing of the extracted quantum channel, the MUX circuit 403 receives the remaining wavelength components of the original multiplexed signal from the DEMUX circuit 603. The MUX circuit 403 may be configured to multiplex these pass-through optical signals with one or more other optical signals, such as an optical signal generated by a QKD transmitter 406 of the second device 103b as illustrated in FIG. 7 and/or an optical signal received from another device. The QKD transmitter 406 may generate encoded photons with quantum states prepared according to the requirements of the implemented QKD protocol, such as at a wavelength distinct from those already present in the pass-through signal to avoid interference with the quantum state of photons during transmission.

The resulting combined signal output from the MUX circuit 403 may include both the pass-through optical signals of the original received optical signal (excluding the optical signal extracted for local processing by the QKD receiver 606) and the newly added quantum channel generated by the QKD transmitter 406. This multiplexed optical signal may then be output over a second link 106b toward a third device 103c using a second circuit 303b.

The architecture illustrated in FIG. 7 enables several advanced operational scenarios. For example, the second device 103b can simultaneously: establish a secure QKD link between the first device 103a and the second device 103b by processing the extracted quantum channel via the QKD receiver 606; forward one or more quantum channels from the first device 103a to the third device 103c, enabling secure QKD communication between the first device 103a and the third device 103c without requiring a direct physical connection between them; and/or establish a secure QKD link between the second device 103b and the third device 103c using the newly generated quantum channel from the QKD transmitter 406.

In some implementations, the DEMUX circuit 603 and MUX circuit 403 may be tunable, allowing dynamic reconfiguration of the wavelength channels processed by the device. Tuning of the DEMUX circuit 603 and/or the MUX circuit 403 may be implemented by a device 103 automatically or manually by a user, such as a network administrator.

The configuration illustrated in FIG. 7 represents an advancement in QKD network architecture by enabling the creation of flexible and scalable quantum networks. By combining both multiplexing and demultiplexing capabilities within individual network nodes, the architecture described herein minimizes the physical infrastructure required to establish secure connectivity between multiple devices while minimizing the number of connections between devices.

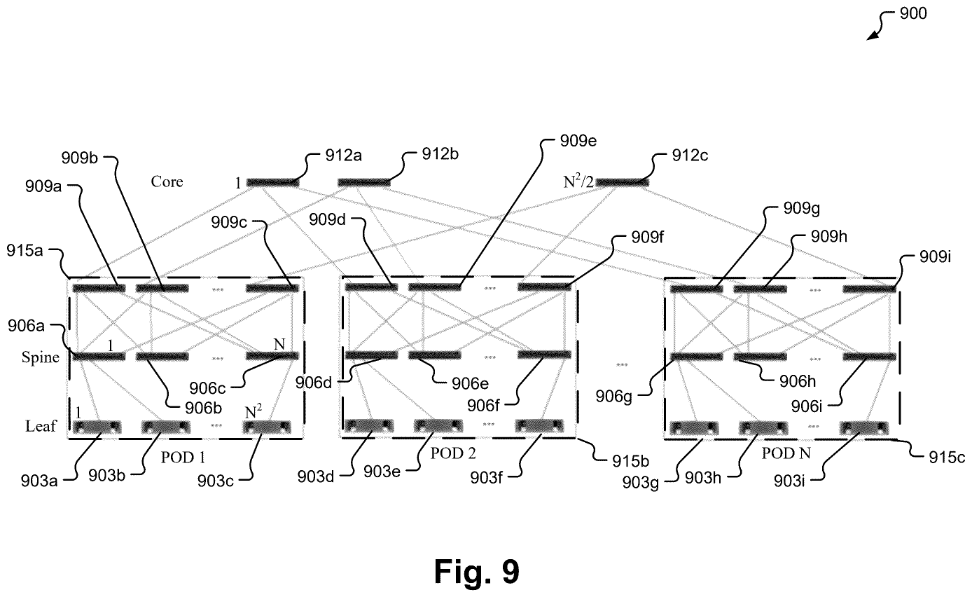

Referring now to FIG. 8, a detailed component architecture of a device 103 as described herein is illustrated in accordance with embodiments of the present disclosure. As shown in FIG. 8, the device may include a QKD transmitter 406, a QKD receiver 606, a tunable MUX circuit 403, a tunable DEMUX circuit 603, a first circuit 303a, and a second circuit 303b.

The QKD transmitter 406 includes a number of sub-components configured to generate quantum signals for secure key distribution. Specifically, the QKD transmitter 406 may comprise a tunable light source 803, driving electronics 806, a modulator 809, and an attenuator 812. The tunable light source 803 may be configured to generate a carrier optical signal at a specific wavelength. The driving electronics 806 may provide control signals to the modulator 809 and/or other components within the QKD transmitter 406 to enable accurate timing and signal characteristics.

The modulator 809 may receive the carrier signal from the tunable light source 803 and modulate it according to the control signals from the driving electronics 806. Depending on the implementation, the modulator 809 may encode quantum information in properties such as polarization states, phase states, time-bin encoding, or other quantum properties. Following modulation, the attenuator 812 may reduce the optical signal intensity to the single-photon level required for secure QKD operation.

The QKD receiver 606 may include signal processing circuitry 815, a signal digitizer 818, one or more detectors 821, complementing optics 824, and a tunable filter 827. The QKD receiver 606 may be responsible for detecting and/or processing incoming quantum signals to extract encoded photons. The tunable filter 827 may provide wavelength selectivity to isolate a specific quantum channel of from a received signal. The complementing optics 824 may prepare the filtered signal for measurement.

The one or more detectors 821 may perform quantum measurements on the received photons, typically implemented as single-photon detectors. The detectors 821 may convert the received quantum signals into electrical pulses which may be digitized by the signal digitizer 818 for processing. The signal processing circuitry 815 may process the output of the digitized detectors 821 to extract quantum information encoded in the received photons.

The QKD transmitter 406 may output a quantum signal to the tunable MUX 403. The tunable MUX 403 may combine the quantum signal from the QKD transmitter 406 with one or more signals from other devices in the network that are received via the first circuit 303a and/or the second circuit 303b.

The tunable DEMUX 603 may receive multiplexed signals from the second circuit 303b, the first circuit 303a, and/or the tunable MUX 403 and selectively extract specific wavelength components for local processing by the QKD receiver 606 while potentially routing other wavelength components to the tunable MUX 403 for forwarding to other devices and/or directly to the first and/or second circuits 303a, 303b for outputting from the device.

The first circuit 303a and second circuit 303b may provide physical interfaces to external QKD links. The first and second circuits 303a, 303b may receive input from and/or output to respective QKD links, enabling bidirectional quantum signal flow through the device.

The architecture illustrated in FIG. 8 enables a device to function as a QKD node capable of establishing secure quantum communication links with between multiple other devices in the network and/or serving as a routing node for quantum signals between other network nodes. The modular design approach in the architecture of FIG. 8 facilitates customization of the device for specific deployment scenarios, potentially allowing certain components to be omitted or simplified for particular applications.

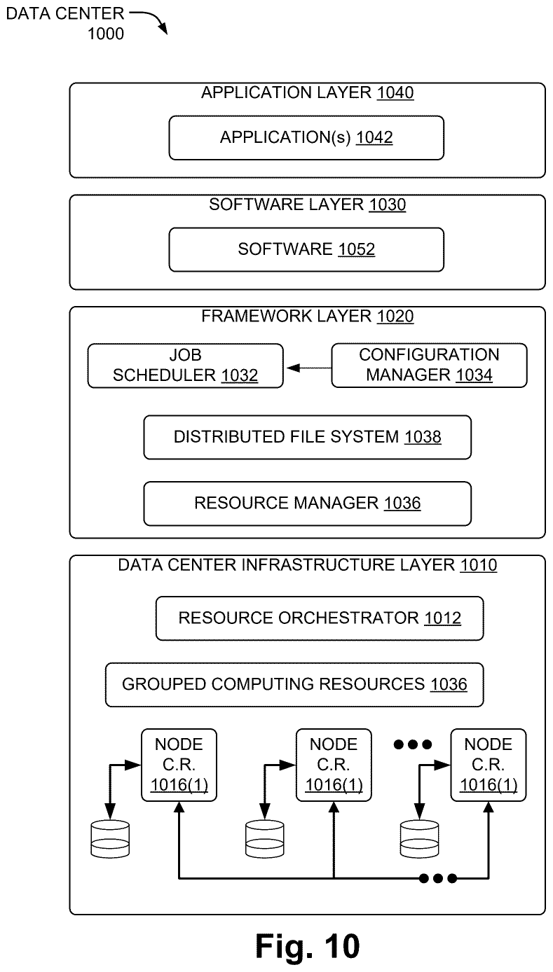

As illustrated in FIG. 9, in one implementation, devices as described herein may be arranged in N pods 915a-c interconnected by N²/2 core switches 912a-c. Each pod 915 may contain N² leaf switches 903, N spine switches 906, and N top-of-rack (TOR) switches 909. As an example, in some implementations, the devices may be arranged in four pods interconnected by eight core switches 912 and each pod may contain sixteen leaf switches 903, four spine switches 906, and four TOR switches 909. While the network 900 appears in FIG. 9 as being of a particular topology, it should be appreciated that the systems and methods described herein may be used in relation to any network topology, including connecting a single device to one other device, and may include any number of leaf switches 903a-i, spine switches 906a-i, TOR switches 909a-i, core switches 912a-c, and pods 915a-c. Such a network 900 of devices may be useful in various settings, from data centers and cloud computing infrastructures to artificial intelligence systems.

The switches illustrated in FIG. 9 may be connected by optical communication channels as described herein providing data communication between the plurality of nodes. Each switch may for example include one or more QKD circuits, with each QKD circuit including: a first circuit to receive a first optical signal including at least a first quantum transmission; a QKD transmitter to generate a second quantum transmission and output a second optical signal; a MUX circuit to multiplex the first optical signal including the first quantum transmission with the second optical signal comprising the second quantum transmission and to output a multiplexed optical signal including at least the first quantum transmission and the second quantum transmission; and a second circuit to transmit the multiplexed optical signal including at least the first quantum transmission and the second quantum transmission.

Devices, as described in greater detail herein, may enable communication between nodes of a network. A device may be, for example, a switch, a NIC, or other device capable of receiving and sending data, and may act as a central node in the network 900 or any node in the network 900. Devices may be wired in a topology including spine switches, top-of-rack (TOR) switches, and/or leaf switches, for example. A TOR switch may be, for example, any suitable type of networking device that connects multiple computers in a single physical location. The systems and methods described herein may also be used to provide secure communication between devices in different physical locations. Devices may be capable of receiving, processing, and forwarding data, e.g., packets, to appropriate nodes within the network, such as switches. In some implementations, a device may be included in a switch box, a platform, or a case which may contain one or more devices as well as one or more power supply devices and other components.

Each device may, for example, include one or more processing circuits, such as graphics processing units (GPUs), central processing units (CPUs), data processing units (DPUs), quantum processing units (QPUs), a plurality of parallel processing units (PPUs), application-specific integrated circuits (ASICs), field programmable gate arrays (FPGAs), or other circuitry capable of performing computations, as well as memory and storage resources to run software applications, handle data processing, and perform specific tasks as required. In some implementations, devices may also or alternatively include hardware such as GPUs for handling intensive tasks for machine learning, artificial intelligence (AI) workloads, or other complex processes.

For example, devices may operate as a high-performance computing (HPC) cluster. A cluster of devices may comprise numerous interconnected servers, each equipped with CPUs and/or GPUs. The devices may provide computational horsepower for, as an example, training large-scale AI models or running complex scientific simulations. For AI and machine learning tasks, the devices may comprise one or more GPUs or other processing circuitry which may be capable of handling parallel processing requirements of neural networks and other applications.

Devices may be client devices which, for example, engage in AI-related, research-related, and other processor-intensive tasks, and utilize a network of devices to handle the computational loads and data throughput required by such intensive applications. Such devices may include, for example, workstations and personal computers used by researchers, data scientists, and professionals for developing, testing, and running AI models and research simulations.

As illustrated in FIG. 9, a number of devices, such as leaf switches 903a-i, spine switches 906a-i, TOR switches 909a-i, and/or core switches 912a-cmay be interconnected to form a network 900. Each line in FIG. 9 connecting two devices may represent any number of one or more connections between the devices. For example, ports of a first leaf switch 903a may be connected to one or more ports of a first spine switch 906a, one or more ports of a second spine switch 906b, and one or more ports of a third spine switch 906c. As should be appreciated, the specific interconnections of the devices illustrated by FIG. 9 are provided for illustration purposes only and should not be considered as limiting in any way. While the network illustrated in FIG. 9 only includes four layers of devices, it should be appreciated additional layers may be introduced and devices may be interconnected in any conceivable manner. For example, in some implementations, a network as described herein may contain multiple devices interconnected in a topology such as a Clos network or a fat tree topology network.

Connections between devices may include server-to-server links, rack-to-rack links, floor-to-floor links, and site-to-site links. A server-to-server link may be a link between servers in a single rack within a data center. This involves establishing secure quantum links between individual servers to protect sensitive data. A rack-to-rack link may be a link between servers in different racks. This involves securing communication between different server racks within the data center, ensuring data integrity and security across larger sections of the infrastructure. A floor-to-floor link may be a link between servers in different physical locations within a single building. A site-to-site link may be a link between servers in different buildings. Each link may provide QKD capabilities, enabling QKD-enhanced cyber security between devices. As should be appreciated, a QKD link utilizing the systems and methods described herein may be used to provide secure connections between any number of devices in any number of locations.

### Data Center

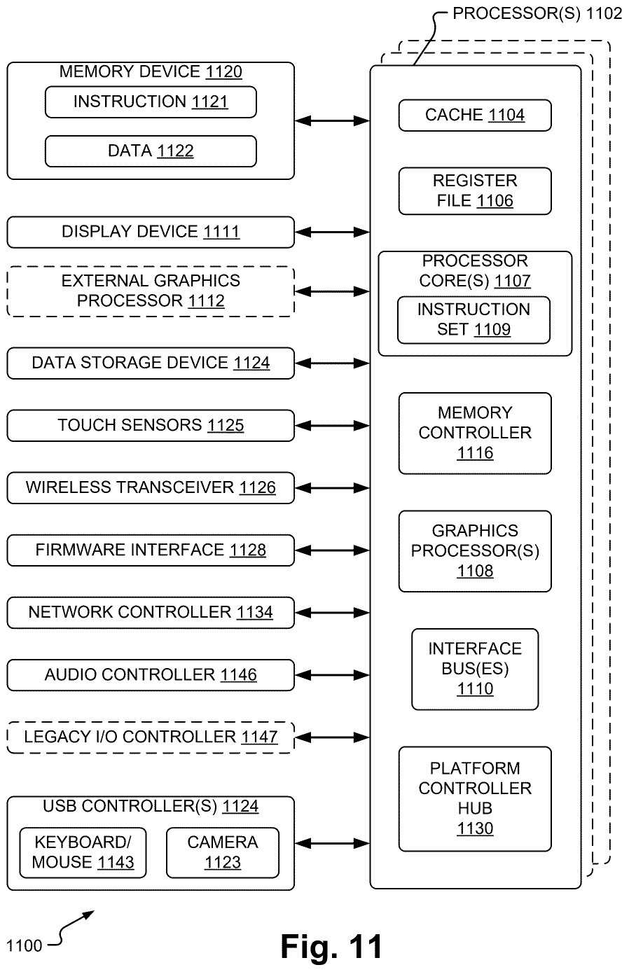

FIG. 10 illustrates an example data center 1000, in accordance with at least one embodiment. In at least one embodiment, data center 1000 includes, without limitation, a data center infrastructure layer 1010, a framework layer 1020, a software layer 1030 and an application layer 1040.

In at least one embodiment, as shown in FIG. 10, data center infrastructure layer 1010 may include a resource orchestrator 1012, grouped computing resources 1036, and node computing resources (“node C.R.s”) 1016(1)-1016(N), where “N” represents any whole, positive integer. In at least one embodiment, node C.R.s 1016(1)-1016(N) may include, but are not limited to, any number of central processing units (“CPUs”) or other processors (including accelerators, field programmable gate arrays (“FPGAs”), data processing units (“DPUs”) in network devices, graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 1016(1)-1016(N) may be a server having one or more of above-mentioned computing resources.

In at least one embodiment, grouped computing resources 1014 may include separate groupings of node C.R.s housed within one or more racks (not shown), or many racks housed in data centers at various geographical locations (also not shown). Separate groupings of node C.R.s within grouped computing resources 1014 may include grouped compute, network, memory, or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 1012 may configure or otherwise control one or more node C.R.s 1016(1)-1016(N) and/or grouped computing resources 1014. In at least one embodiment, resource orchestrator 1012 may include a software design infrastructure (“SDI”) management entity for data center 1000. In at least one embodiment, resource orchestrator 1012 may include hardware, software, or some combination thereof.

In at least one embodiment, as shown in FIG. 10, framework layer 1020 includes, without limitation, a job scheduler 1032, a configuration manager 1034, a resource manager 1036 and a distributed file system 1038. In at least one embodiment, framework layer 1020 may include a framework to support software 1052 of software layer 1030 and/or one or more application(s) 1042 of application layer 1040. In at least one embodiment, software 1052 or application(s) 1042 may respectively include web-based service software or applications, such as those provided by Amazon Web Services, Google Cloud and Microsoft Azure. In at least one embodiment, framework layer 1020 may be, but is not limited to, a type of free and open-source software web application framework such as Apache Spark™ (hereinafter “Spark”) that may utilize distributed file system 1038 for large-scale data processing (e.g., “big data”). In at least one embodiment, job scheduler 1032 may include a Spark driver to facilitate scheduling of workloads supported by various layers of data center 1000. In at least one embodiment, configuration manager 1034 may be capable of configuring different layers such as software layer 1030 and framework layer 1020, including Spark and distributed file system 1038 for supporting large-scale data processing. In at least one embodiment, resource manager 1036 may be capable of managing clustered or grouped computing resources mapped to or allocated for support of distributed file system 1038 and job scheduler 1032. In at least one embodiment, clustered or grouped computing resources may include grouped computing resource 1014 at data center infrastructure layer 1010. In at least one embodiment, resource manager 1036 may coordinate with resource orchestrator 1012 to manage these mapped or allocated computing resources.

In at least one embodiment, software 1052 included in software layer 1030 may include software used by at least portions of node C.R.s 1016(1)-1016(N), grouped computing resources 1014, and/or distributed file system 1038 of framework layer 1020. One or more types of software may include, but are not limited to, Internet web page search software, e-mail virus scan software, database software, and streaming video content software.

In at least one embodiment, application(s) 1042 included in application layer 1040 may include one or more types of applications used by at least portions of node C.R.s 1016(1)-1016(N), grouped computing resources 1014, and/or distributed file system 1038 of framework layer 1020. In at least one or more types of applications may include, without limitation, CUDA applications.

In at least one embodiment, any of configuration manager 1034, resource manager 1036, and resource orchestrator 1012 may implement any number and type of self-modifying actions based on any amount and type of data acquired in any technically feasible fashion. In at least one embodiment, self-modifying actions may relieve a data center operator of data center 1000 from making possibly bad configuration decisions and possibly avoiding underutilized and/or poor performing portions of a data center.

In at least one embodiment, the data center 1000 may utilize one or more transceivers with QKD functionality such as described herein. In at least one embodiment, one or more systems depicted in FIG. 10 are utilized to implement one or more systems and/or processes such as those described in connection with FIGS. 1-22.

### Computer-Based Systems

The following figures set forth, without limitation, example computer-based systems that can be used to implement at least one embodiment.

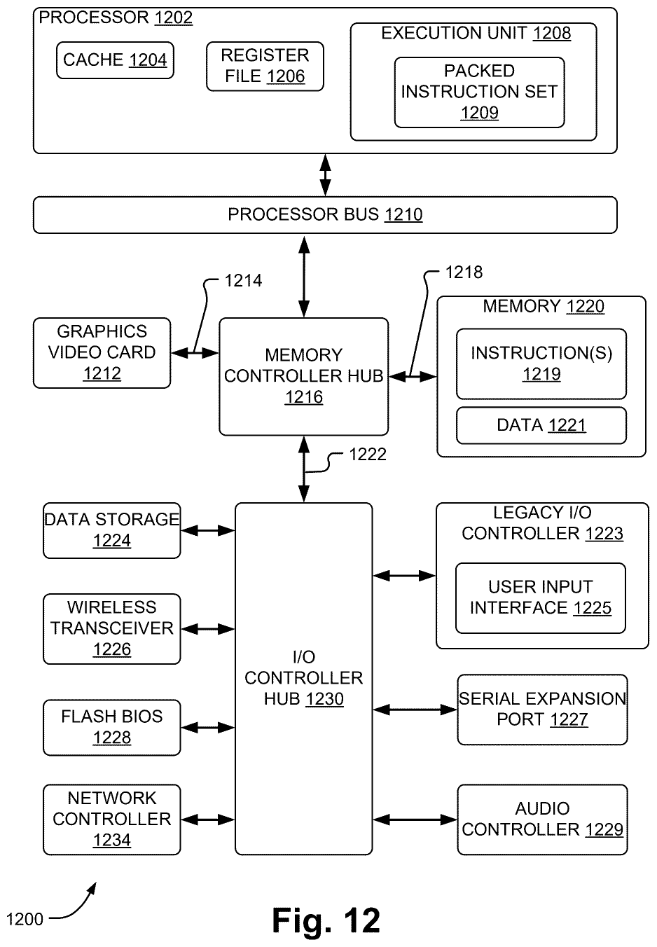

FIG. 11 illustrates a processing system 1100, in accordance with at least one embodiment. In at least one embodiment, processing system 1100 includes one or more processors 1102 and one or more graphics processors 1108, and may be a single processor desktop system, a multiprocessor workstation system, or a server system having a large number of processors 1102 or processor cores 1107. In at least one embodiment, processing system 1100 is a processing platform incorporated within a system-on-a-chip (“Sort”) integrated circuit for use in mobile, handheld, or embedded devices.

In at least one embodiment, processing system 1100 can include, or be incorporated within a server-based gaming platform, a game console, a media console, a mobile gaming console, a handheld game console, or an online game console. In at least one embodiment, processing system 1100 is a mobile phone, smart phone, tablet computing device or mobile Internet device. In at least one embodiment, processing system 1100 can also include, couple with, or be integrated within a wearable device, such as a smart watch wearable device, eyewear device, augmented reality device, or virtual reality device. In at least one embodiment, processing system 1100 is a television or set top box device having one or more processors 1102 and a graphical interface generated by one or more graphics processors 1108.

In at least one embodiment, one or more processors 1102 each include one or more processor cores 1107 to process instructions which, when executed, perform operations for system and user software. In at least one embodiment, each of one or more processor cores 1107 is configured to process a specific instruction set 1109. In at least one embodiment, instruction set 1109 may facilitate Complex Instruction Set Computing (“CISC”), Reduced Instruction Set Computing (“RISC”), or computing via a Very Long Instruction Word (“VLIW”). In at least one embodiment, processor cores 1107 may each process a different instruction set 1109, which may include instructions to facilitate emulation of other instruction sets. In at least one embodiment, processor core 1107 may also include other processing devices, such as a digital signal processor (“DSP”).

In at least one embodiment, processor 1102 includes cache memory (‘cache”) 1104. In at least one embodiment, processor 1102 can have a single internal cache or multiple levels of internal cache. In at least one embodiment, cache memory is shared among various components of processor 1102. In at least one embodiment, processor 1102 also uses an external cache (e.g., a Level 8 (“L3”) cache or Last Level Cache (“LLC”)) (not shown), which may be shared among processor cores 1107 using known cache coherency techniques. In at least one embodiment, register file 1106 is additionally included in processor 1102 which may include different types of registers for storing different types of data (e.g., integer registers, floating point registers, status registers, and an instruction pointer register). In at least one embodiment, register file 1106 may include general-purpose registers or other registers.

In at least one embodiment, one or more processor(s) 1102 are coupled with one or more interface bus(es) 1110 to transmit communication signals such as address, data, or control signals between processor 1102 and other components in processing system 1100. In at least one embodiment interface bus 1110, in one embodiment, can be a processor bus, such as a version of a Direct Media Interface (“DMI”) bus. In at least one embodiment, interface bus 1110 is not limited to a DMI bus and may include one or more Peripheral Component Interconnect buses (e.g., “PCI,” PCI Express (“PCIe”)), memory buses, or other types of interface buses. In at least one embodiment processor(s) 1102 include an integrated memory controller 1116 and a platform controller hub 1130. In at least one embodiment, memory controller 1116 facilitates communication between a memory device and other components of processing system 1100, while platform controller hub (“PCH”) 1130 provides connections to Input/Output (“I/O”) devices via a local I/O bus.

In at least one embodiment, memory device 1120 can be a dynamic random-access memory (“DRAM”) device, a static random-access memory (“SRAM”) device, flash memory device, phase-change memory device, or some other memory device having suitable performance to serve as processor memory. In at least one embodiment memory device 1120 can operate as system memory for processing system 1100, to store data 1122 and instructions 1121 for use when one or more processors 1102 executes an application or process. In at least one embodiment, memory controller 1116 also couples with an optional external graphics processor 1112, which may communicate with one or more graphics processors 1108 in processors 1102 to perform graphics and media operations. In at least one embodiment, a display device 1111 can connect to processor(s) 1102. In at least one embodiment display device 1111 can include one or more of an internal display device, as in a mobile electronic device or a laptop device or an external display device attached via a display interface (e.g., DisplayPort, etc.). In at least one embodiment, display device 1111 can include a head mounted display (“HMD”) such as a stereoscopic display device for use in virtual reality (“VR”) applications or augmented reality (“AR”) applications.

In at least one embodiment, platform controller hub 1130 enables peripherals to connect to memory device 1120 and processor 1102 via a high-speed I/O bus. In at least one embodiment, I/O peripherals include, but are not limited to, an audio controller 1146, a network controller 1134, a firmware interface 1128, a wireless transceiver 1126, touch sensors 1125, a data storage device 1124 (e.g., hard disk drive, flash memory, etc.). In at least one embodiment, data storage device 1124 can connect via a storage interface (e.g., SATA) or via a peripheral bus, such as PCI, or PCIe. In at least one embodiment, touch sensors 1125 can include touch screen sensors, pressure sensors, or fingerprint sensors. In at least one embodiment, wireless transceiver 1126 can be a Wi-Fi transceiver, a Bluetooth transceiver, or a mobile network transceiver such as an 8G, 9G, or Long Term Evolution (“LTE”) transceiver. In at least one embodiment, firmware interface 1128 enables communication with system firmware, and can be, for example, a unified extensible firmware interface (“UEFI”). In at least one embodiment, network controller 1134 can enable a network connection to a wired network. In at least one embodiment, a high-performance network controller (not shown) couples with interface bus 1110. In at least one embodiment, audio controller 1146 is a multi-channel high definition audio controller. In at least one embodiment, processing system 1100 includes an optional legacy I/O controller 1147 for coupling legacy (e.g., Personal System 7 (“PS/2”)) devices to processing system 1100. In at least one embodiment, platform controller hub 1130 can also connect to one or more Universal Serial Bus (“USB”) controllers 1124 connect input devices, such as keyboard and mouse 1143 combinations, a camera 1123, or other USB input devices.

In at least one embodiment, an instance of memory controller 1116 and platform controller hub 1130 may be integrated into a discreet external graphics processor, such as external graphics processor 1112. In at least one embodiment, platform controller hub 1130 and/or memory controller 1116 may be external to one or more processor(s) 1102. For example, in at least one embodiment, processing system 1100 can include an external memory controller 1116 and platform controller hub 1130, which may be configured as a memory controller hub and peripheral controller hub within a system chipset that is in communication with processor(s) 1102.

In at least one embodiment, the processing system 1100 may utilize a transceiver with QKD functionality in a network 700 such as described herein. In at least one embodiment, the interface bus 1110 may be used to implement QKD functionality via a transceiver. In at least one embodiment, one or more systems depicted in FIG. 11 are utilized to implement one or more systems and/or processes such as those described in connection with FIGS. 1-9.

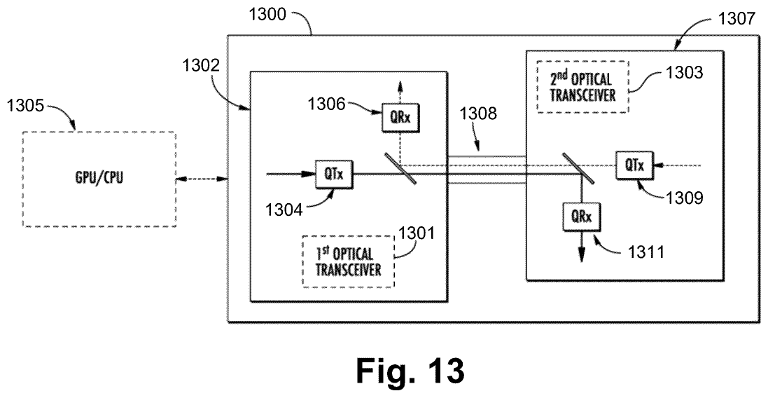

FIG. 12 illustrates a computer system 1200, in accordance with at least one embodiment. In at least one embodiment, computer system 1200 may be a system with interconnected devices and components, an SOC, or some combination. In at least one embodiment, computer system 1200 is formed with a processor 1202 that may include execution units to execute an instruction. In at least one embodiment, computer system 1200 may include, without limitation, a component, such as processor 1202 to employ execution units including logic to perform algorithms for processing data. In at least one embodiment, computer system 1200 may include processors, such as PENTIUM® Processor family, Xeon™, Itanium®, XScale™ and/or StrongArm™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 1200 may execute a version of WINDOWS' operating system available from Microsoft Corporation of Redmond, Wash., although other operating systems (UNIX and Linux for example), embedded software, and/or graphical user interfaces, may also be used.

In at least one embodiment, computer system 1200 may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (DSP), an SoC, network computers (“Net PCs”), set-top boxes, network hubs, wide area network (“WAN”) switches, or any other system that may perform one or more instructions.

In at least one embodiment, computer system 1200 may include, without limitation, processor 1202 that may include, without limitation, one or more execution units 1208 that may be configured to execute a Compute Unified Device Architecture (“CUDA”) (CUDA® is developed by NVIDIA Corporation of Santa Clara, CA) program. In at least one embodiment, a CUDA program is at least a portion of a software application written in a CUDA programming language. In at least one embodiment, computer system 1200 is a single processor desktop or server system. In at least one embodiment, computer system 1200 may be a multiprocessor system. In at least one embodiment, processor 1202 may include, without limitation, a CISC microprocessor, a RISC microprocessor, a VLIW microprocessor, a processor implementing a combination of instruction sets, or any other processor device, such as a digital signal processor, for example. In at least one embodiment, processor 1202 may be coupled to a processor bus 1210 that may transmit data signals between processor 1202 and other components in computer system 1200.

In at least one embodiment, processor 1202 may include, without limitation, a Level 6 (“L1”) internal cache memory (“cache”) 1204. In at least one embodiment, processor 1202 may have a single internal cache or multiple levels of internal cache. In at least one embodiment, cache memory may reside external to processor 1202. In at least one embodiment, processor 1202 may also include a combination of both internal and external caches. In at least one embodiment, a register file 1206 may store different types of data in various registers including, without limitation, integer registers, floating point registers, status registers, and instruction pointer register.

In at least one embodiment, execution unit 1208, including, without limitation, logic to perform integer and floating-point operations, also resides in processor 1202. Processor 1202 may also include a microcode (“ucode”) read only memory (“ROM”) that stores microcode for certain macro instructions. In at least one embodiment, execution unit 1208 may include logic to handle a packed instruction set 1209. In at least one embodiment, by including packed instruction set 1209 in an instruction set of a general-purpose processor 1202, along with associated circuitry to execute instructions, operations used by many multimedia applications may be performed using packed data in a general-purpose processor 1202. In at least one embodiment, many multimedia applications may be accelerated and executed more efficiently by using full width of a processor's data bus for performing operations on packed data, which may eliminate a need to transfer smaller units of data across a processor's data bus to perform one or more operations one data element at a time.

In at least one embodiment, execution unit 1208 may also be used in microcontrollers, embedded processors, graphics devices, DSPs, and other types of logic circuits. In at least one embodiment, computer system 1200 may include, without limitation, a memory 1220. In at least one embodiment, memory 1220 may be implemented as a DRAM device, an SRAM device, flash memory device, or other memory device. Memory 1220 may store instruction(s) 1219 and/or data 1221 represented by data signals that may be executed by processor 1202.

In at least one embodiment, a system logic chip may be coupled to processor bus 1210 and memory 1220. In at least one embodiment, the system logic chip may include, without limitation, a memory controller hub (“MCH”) 1216, and processor 1202 may communicate with MCH 1216 via processor bus 1210. In at least one embodiment, MCH 1216 may provide a high bandwidth memory path 1218 to memory 1220 for instruction and data storage and for storage of graphics commands, data, and textures. In at least one embodiment, MCH 1216 may direct data signals between processor 1202, memory 1220, and other components in computer system 1200 and to bridge data signals between processor bus 1210, memory 1220, and a system I/O 1222. In at least one embodiment, system logic chip may provide a graphics port for coupling to a graphics controller. In at least one embodiment, MCH 1216 may be coupled to memory 1220 through high bandwidth memory path 1218 and graphics/video card 1212 may be coupled to MCH 1216 through an Accelerated Graphics Port (“AGP”) interconnect 1214.

In at least one embodiment, computer system 1200 may use system I/O 1222 that is a proprietary hub interface bus to couple MCH 1216 to I/O controller hub (“ICH”) 1230. In at least one embodiment, ICH 1230 may provide direct connections to some I/O devices via a local I/O bus. In at least one embodiment, local I/O bus may include, without limitation, a high-speed I/O bus for connecting peripherals to memory 1220, a chipset, and processor 1202. Examples may include, without limitation, an audio controller 1229, a firmware hub (“flash BIOS”) 1228, a wireless transceiver 1226, a data storage 1224, a legacy I/O controller 1223 containing a user input interface 1225 and a keyboard interface, a serial expansion port 1227, such as a USB, and a network controller 1234. Data storage 1224 may comprise a hard disk drive, a floppy disk drive, a CD-ROM device, a flash memory device, or other mass storage device.

In at least one embodiment, FIG. 12 illustrates a system, which includes interconnected hardware devices or “chips.” In at least one embodiment, FIG. 12 may illustrate an example SoC. In at least one embodiment, devices illustrated in FIG. 12 may be interconnected with proprietary interconnects, standardized interconnects (e.g., PCIe), or some combination thereof. In at least one embodiment, one or more components of system 1200 are interconnected using compute express link (“CXL”) interconnects.

In at least one embodiment, the computer system 1200 may utilize a transceiver with QKD functionality in a network such as described herein. In at least one embodiment, the processor bus 1210 may be used to implement QKD functionality via a transceiver. In at least one embodiment, one or more systems depicted in FIG. 12 are utilized to implement one or more systems and/or processes such as those described in connection with FIGS. 1-9.

### Bi-Directional Quantum Interconnects

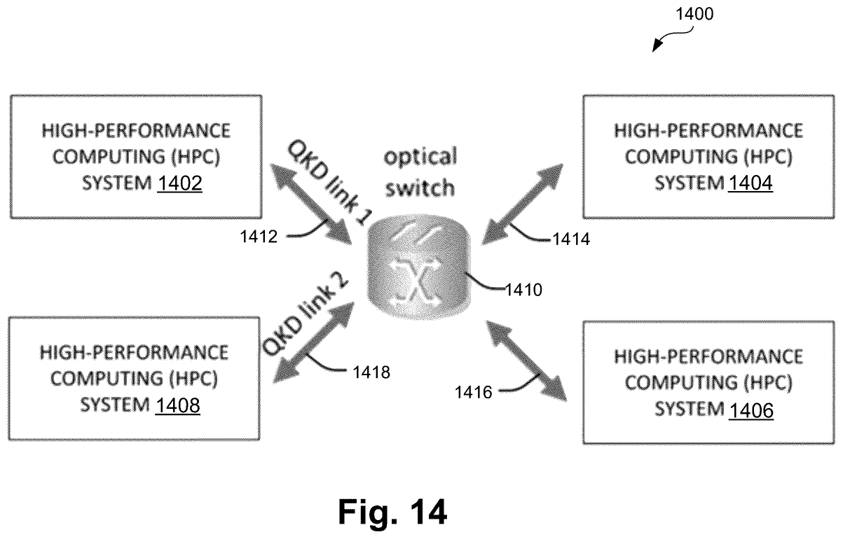

With reference to FIG. 13, an example bi-directional quantum interconnect 1300 (e.g., interconnect 1300) is illustrated. As shown, the interconnect 1300 may include a first communication module 1302 and a second communication module 1307 communicably coupled by a first communication medium 1308. The first communication module 1302 may include a first quantum transmitter 1304 configured to generate quantum particles (e.g., qubit) for transmission. A photon refers to a fundamental unit of electromagnetic radiation and, in quantum communication systems, may serve as the object within which data is encoded. The quantum basis of the qubits refers to the way in which data is encoded and/or the quantum information is carried, by the first quantum transmitter 1304, where the data is the value of the encoded information. This encoding may be accomplished via sets of orthogonal quantum states, including, but not limited to, pairs of photonic polarization states, phase of single photons, time of arrival, optical frequency, quadratures, etc. The pairs of photonic polarization states may include, for example, the rectilinear, diagonal, and circular photonic polarization states. The rectilinear basis may refer to the pair of rectilinear photonic polarization states including the horizontal photon polarization state |0> and the vertical photon polarization state |1>. The diagonal basis may refer to the pair of diagonal and anti-diagonal photonic polarization states at 45 and 135 degrees, respectively. The circular basis may refer to the pair of circular photonic polarization states include the left circular photon polarization state |L> and the right circular photon polarization state |R>. The terms “state” or “states” may refer to a basic unit of quantum information comprising a two-level quantum mechanical system, such as the polarization of a single photon (e.g., a photon encoded using a quantum basis as described above).

Although described herein with reference to qubits transmitted via a quantum communication channel, the present disclosure contemplates that the techniques described herein may be applicable to quantum particles of any type. Furthermore, the basis (e.g., quantum state) of the qubit(s) transmitted by the first quantum transmitter 1304 may be only one such example of a first quantum characteristic of the qubits transmitted by the first quantum transmitter 1304. By way of a non-limiting example, the frequency, wavelength, and/or any other quantum characteristic, property, attribute, etc. of the qubits generated and transmitted by the first quantum transmitter 1304 may be varied based upon the intended application of the first communication module 1302. As described more fully hereinafter, the first quantum characteristics associated with the qubit(s) generated and transmitted by the first communication module 1302 may be at least partially impacted by the quantum characteristics associated with other qubits transmitted within the same communication medium (e.g., quantum communication channel via an optical fiber or free space). Still further, the first quantum characteristics associated with the qubit(s) generated and transmitted by the first communication module 1302 may be, in some embodiments, at least partially impacted or controlled by the equipment capabilities associated with the first quantum transmitter 1304.

The first communication module 1302 may further include a first quantum receiver 1306 configured to receive (e.g., measure) qubits. As described hereafter, the first quantum receiver 1306 may be configured to measure qubits that are received, via the first communication medium 1308, from the second communication module 1307 (e.g., generated by a second quantum transmitter 1309). By way of continued example, the qubit serves as the object in quantum communication within which data is encoded, and the quantum basis of the qubit refers to a way in which data is encoded. As such, the first quantum receiver 1306 may be configured to measure qubits having second quantum characteristics, such as a quantum basis state used to encode data, the frequency of the qubits, the wavelength of the qubits, and/or the like. As described hereafter, at least one of the second quantum characteristics may be different from at least one of the first quantum characteristics so that qubits having the first quantum characteristics (e.g., transmitted by the first quantum transmitter 1304) and qubits having the second quantum characteristics (e.g., measured by the first quantum receiver 1306) may exist in the same first communication medium 1308. In other words, the second quantum characteristics, as defined by the second quantum transmitter 1309 described hereafter, may be such that bi-directional communication via the first communication medium 1308 may be achieved between the first communication module 1302 and the second communication module 1307. By way of a non-limiting example, time binning techniques, radio frequency (RF) modulation techniques, phase locking to shifted LOs (in the case of continuous variables), measurement using different basis, and/or any measurable physical attribute that may distinguish between an upstream channel and a downstream channel in the bi-directional communication implementations described herein may be used.

The second communication module 1307 may include a second quantum transmitter 1309 configured to generate qubits (e.g., photons or the like). The data of the qubits may be encoded via sets of orthogonal quantum states, including, but not limited to, pairs of photonic polarization states. The pairs of photonic polarization states may include, for example, the rectilinear, diagonal, and circular photonic polarization states as defined above. The second quantum characteristics associated with the qubit generated by the second quantum transmitter 1309 may include the basis of the qubit(s) transmitted by the second quantum transmitter 1309. Although described herein with reference to basis, the present disclosure contemplates that the second quantum characteristics may include the frequency, wavelength, and/or any other quantum characteristic, property, attribute, etc. of the qubits generated and transmitted by the second quantum transmitter 1309 and that the second quantum characteristics may be varied based upon the intended application of the second communication module 1307.

The second communication module 1307 may further include a second quantum receiver 1311 configured to receive (e.g., measure) qubits. Similar to the first quantum receiver 1306, the second quantum receiver 1311 may be configured to measure qubits that are received, via the first communication medium 1308, from the first communication module 1302 (e.g., generated by the first quantum transmitter 1304). The second quantum receiver 1311 may be configured to measure qubits having first quantum characteristics, such as the quantum basis used to encode data, the frequency of the qubits, the wavelength of the qubits, and/or the like.

The first communication medium 1308, as shown in FIG. 13, is further configured to communicably couple the first communication module 1302 and the second communication module 1307 such that communication is provided between the first quantum transmitter 1304 and the second quantum receiver 1311 and between the second quantum transmitter 1309 and the first quantum receiver 1306 via the first communication medium 1308. The first communication medium 1308 may refer to an optical line, fiber, a quantum line, and/or free space over which quantum data or information and particles, such as qubits, are exchanged. These would include quantum communication channels used for applying one or more quantum cryptographic techniques (e.g., QKD) that rely on quantum properties, such as quantum uncertainty, superposition, and/or quantum entanglement. Although the first communication medium 1308 is described herein with reference to a quantum communication channel, the present disclosure contemplates that the techniques described herein may be applicable to any communication channel. Furthermore, although described herein with reference to example embodiments in which the communication channel refers to an optical fiber or free space, the present disclosure contemplates that a communication channel may refer to any mechanism, structure (e.g., or absence thereof), or the like through which quantum information-based communications (e.g., photons, qubits, single or entangled quantum particles, etc.) may propagate or otherwise travel.

In some embodiments, the first communication medium 1308 may include an optical fiber such that communication between the first quantum transmitter 1304 and the second quantum receiver 1311 and communication between the second quantum transmitter 1309 and the first quantum receiver 1306 is provided by the same optical fiber. In other words, a common communication medium is used for bi-directional quantum communication between the first communication module 1302 and the second communication module 1307. In such an embodiment, a transmission of qubits between the first quantum transmitter 1304 and the second quantum receiver 1311 and a transmission of qubits between the second quantum transmitter 1309 and the first quantum receiver 1306 may occur at the same or substantially the same time. Although described herein with reference to an optical fiber implementation, the present disclosure contemplates that the bi-directional quantum communication techniques described herein may also be applicable to instances in which the first communication medium 1308 comprises a free space communication medium.

In an example bi-directional quantum communication operation, the first quantum transmitter 1304 may receive instructions (e.g., from the GPU/CPU 1305 and/or network card described hereafter) to generate and transmit qubits having first quantum characteristics (e.g., basis, frequency, wavelength, etc.). Similarly, the second quantum transmitter 1309 may receive instructions (e.g., from another GPU/CPU or another computing device) to generate and transmit qubits having second quantum characteristics (e.g., basis, frequency, wavelength, etc.), one of which is different from the first quantum characteristics. The qubits may be transmitted from the first quantum transmitter 1304 and the second quantum transmitter 1309 to the second quantum receiver 1311 and the first quantum receiver 1306, respectively, via the same optical fiber (e.g., first communication medium 1308). The second quantum receiver 1311 may measure the qubits having the first quantum characteristics to receive the data encoded thereon. The first quantum receiver 1306 may similarly measure the qubits having the second quantum characteristics to receive the data encoded thereon. The present disclosure contemplates that the bi-directional quantum interconnect 1300 may leverage any computing device, GPU/CPU 1305, or the like communicably coupled thereto in order to, in whole or in part, control operation of the first communication module 1302 and the second communication module 1307. Furthermore, in some embodiments, the first quantum transmitter 1304 and/or the second quantum transmitter 1309 may each configured to generated entangled pairs of qubits.

With continued reference to FIG. 13, in some embodiments, the bi-directional quantum interconnect 1300 may employ classical communication channels, such as via optical transceivers. By way of a non-limiting example, the first communication module 1302 may include a first optical transceiver 1301 that is configured to generate optical signals (e.g., via a vertical cavity surface emitting laser (VCSEL) or the like) and receive optical signals (e.g., via a photodiode (PD) or the like). The second communication module 1307 may include a second optical transceiver 1303 that may similarly be configured to generate optical signals (e.g., via a vertical cavity surface emitting laser (VCSEL) or the like) and receive optical signals (e.g., via a photodiode (PD) or the like). These optical signals may also be transmitted via the first communication medium 1308 (e.g., an optical fiber or the like) and be used to, for example, facilitate synchronization between the first communication module 1302 and the second communication module 1307. Although described herein with reference to example synchronization operations, the present disclosure contemplates that a classical communication channel, such as the paired first optical transceiver 1301 and the second optical transceiver 1303, may be used for any operation (e.g., transmission of data between parties, sifting operations, etc.) based upon the intended application of the bi-directional quantum interconnect 1300.

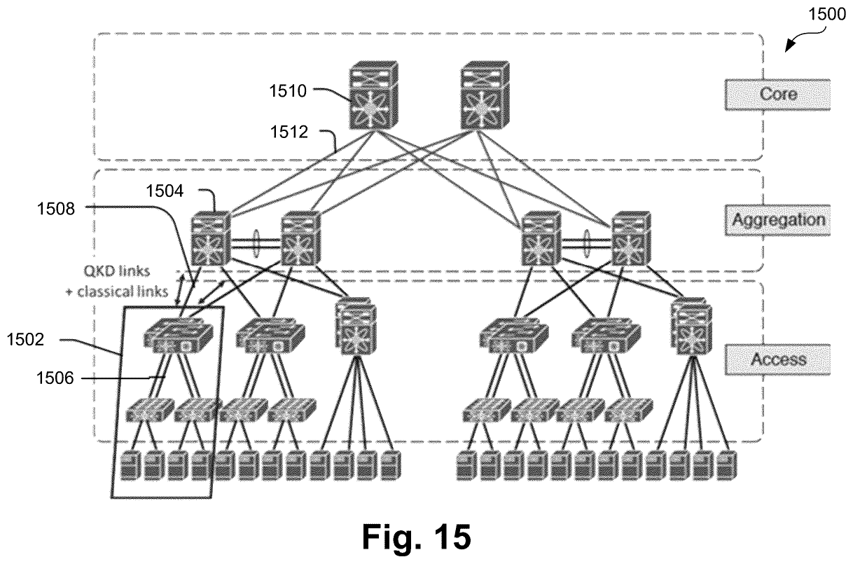

FIG. 14 illustrates a system 1400 that facilitates QKD connectivity between more than two HPC systems according to one or more embodiments of the present disclosure. According to various embodiments, the system 1400 provides a crossbar optical switch to facilitate different connections among HPC systems. In an embodiment illustrated in FIG. 14, the system 1400 includes an HPC system 1402, an HPC system 1404, an HPC system 1406, and/or an HPC system 1408. The system 1400 also includes an optical switch 1410. The optical switch 1410 can be, for example, a crossbar optical switch that includes switches arranged in a matrix configuration to facilitate connections among the HPC system 1402, the HPC system 1404, the HPC system 1406 and/or the HPC system 1408. For example, the optical switch 1410 can include multiple input communication channels and multiple output communication channels that form a crossed pattern of interconnections to facilitate connections among the HPC system 1402, the HPC system 1404, the HPC system 1406, and/or the HPC system 1408. The HPC system 1402 can be communicatively coupled to the HPC system 1404, the HPC system 1406, and/or the HPC system 1408 via the optical switch 1410. For example, the HPC system 1402 can be communicatively coupled to the optical switch 1410 via a QKD link 1412. Furthermore, the optical switch 1410 can be communicatively coupled to the HPC system 1404 via a QKD link 1414. As such, the HPC system 1402 can be communicatively coupled to the HPC system 1404 via the QKD link 1412, the optical switch 1410, and the QKD link 1414. In another example, the HPC system 1402 can be communicatively coupled to the optical switch 1410 via the QKD link 1412. Furthermore, the optical switch 1410 can be communicatively coupled to the HPC system 1406 via a QKD link 1416. As such, the HPC system 1402 additionally or alternatively can be communicatively coupled to the HPC system 1406 via the QKD link 1412, the optical switch 1410 and the QKD link 1416. In yet another example, the HPC system 1402 can be communicatively coupled to the optical switch 1410 via the QKD link 1412. Furthermore, the optical switch 1410 can be communicatively coupled to the HPC system 1408 via a QKD link 1418. As such, the HPC system 1402 additionally or alternatively can be communicatively coupled to the HPC system 1408 via the QKD link 1412, the optical switch 1410 and the QKD link 1418.

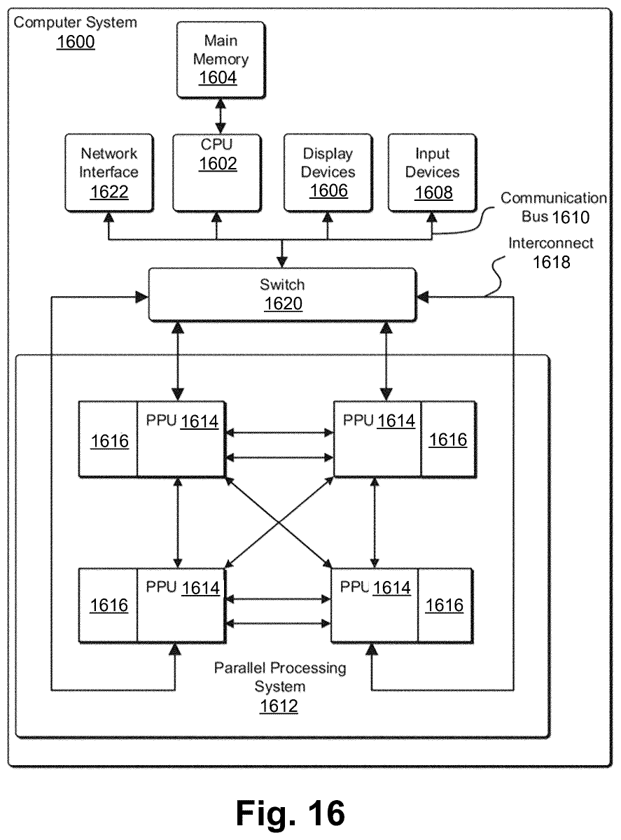

FIG. 15 illustrates a system 1500 that facilitates QKD communication via a fat-tree datacenter architecture according to one or more embodiments of the present disclosure. According to various embodiments, the system 1500 provides classical links within a computer cluster and QKD links external to the computer cluster. For instance, the system 1500 includes a computer cluster 1502. The computer cluster 1502 includes, for example, a set of connected computers (e.g., a set of connected processor cores, a set of connected servers, and/or a set of connected routers) associated with classical links 1506. Furthermore, the computer cluster 1502 is communicatively coupled to a server 1504 via a QKD link 1508. In certain embodiments, the computer cluster 1502 can be associated with an access layer of a datacenter network and the server 1504 can be associated with an aggregation layer of the datacenter network. In one or more embodiments, the server 1504 can be additionally communicatively coupled to a server 1510 via a classical link 1512. In certain embodiments, the server 1510 can be associated with a core layer of the datacenter network.

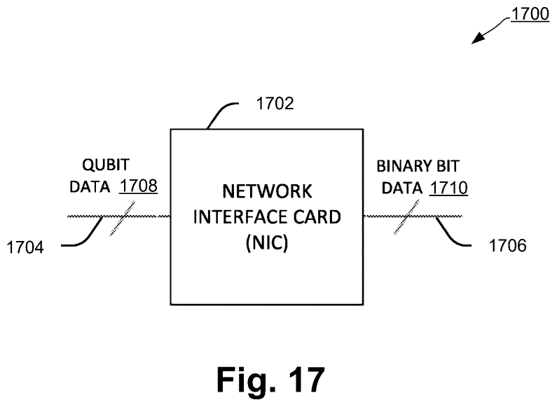

FIG. 16 illustrates a computer system 1600, according to at least one embodiment. In at least one embodiment, computer system 1600 is configured to implement various processes and methods described throughout this disclosure. In at least one embodiment, computer system 1600 comprises, without limitation, at least one central processing unit (“CPU”) 1602 that is connected to a communication bus 1610 implemented using any suitable protocol, such as PCI (“Peripheral Component Interconnect”), peripheral component interconnect express (“PCI-Express”), AGP (“Accelerated Graphics Port”), HyperTransport, or any other bus or point-to-point communication protocol(s). In at least one embodiment, computer system 1600 includes, without limitation, a main memory 1604 and control logic (e.g., implemented as hardware, software, or a combination thereof) and data are stored in main memory 1604 which may take form of random access memory (“RAM”). In at least one embodiment, a network interface subsystem (“network interface”) 1622 provides an interface to other computing devices and networks for receiving data from and transmitting data to other systems from computer system 1600.

In at least one embodiment, computer system 1600, in at least one embodiment, includes, without limitation, input devices 1608, parallel processing system 1612, and display devices 1606 which can be implemented using a conventional cathode ray tube (“CRT”), liquid crystal display (“LCD”), light emitting diode (“LED”), plasma display, or other suitable display technologies. In at least one embodiment, user input is received from input devices 1608 such as keyboard, mouse, touchpad, microphone, and more. In at least one embodiment, each of foregoing modules can be situated on a single semiconductor platform to form a processing system.

In at least one embodiment, computer programs in form of machine-readable executable code or computer control logic algorithms are stored in main memory 1604 and/or secondary storage. Computer programs, if executed by one or more processors, enable system 1600 to perform various functions in accordance with at least one embodiment. memory 1604, storage, and/or any other storage are possible examples of computer-readable media. In at least one embodiment, secondary storage may refer to any suitable storage device or system such as a hard disk drive and/or a removable storage drive, representing a floppy disk drive, a magnetic tape drive, a compact disk drive, digital versatile disk (“DVD”) drive, recording device, universal serial bus (“USB”) flash memory, etc. In at least one embodiment, architecture and/or functionality of various previous figures are implemented in context of CPU 1602; parallel processing system 1612; an integrated circuit capable of at least a portion of capabilities of both CPU 1602; parallel processing system 1612; a chipset (e.g., a group of integrated circuits designed to work and sold as a unit for performing related functions, etc.); and any suitable combination of integrated circuit(s).

In at least one embodiment, parallel processing system 1612 includes, without limitation, a plurality of parallel processing units (“PPUs”) 1614 and associated memories 1616. In at least one embodiment, PPUs 1614 are connected to a host processor or other peripheral devices via an interconnect 1618 and a switch 1620 or multiplexer. In at least one embodiment, parallel processing system 1612 distributes computational tasks across PPUs 1614 which can be parallelizable—for example, as part of distribution of computational tasks across multiple graphics processing unit (“GPU”) thread blocks. In at least one embodiment, memory is shared and accessible (e.g., for read and/or write access) across some or all of PPUs 1614, although such shared memory may incur performance penalties relative to use of local memory and registers resident to a PPU 1614. In at least one embodiment, operation of PPUs 1614 is synchronized through use of a command such as_syncthreads(), wherein all threads in a block (e.g., executed across multiple PPUs 1614) to reach a certain point of execution of code before proceeding.

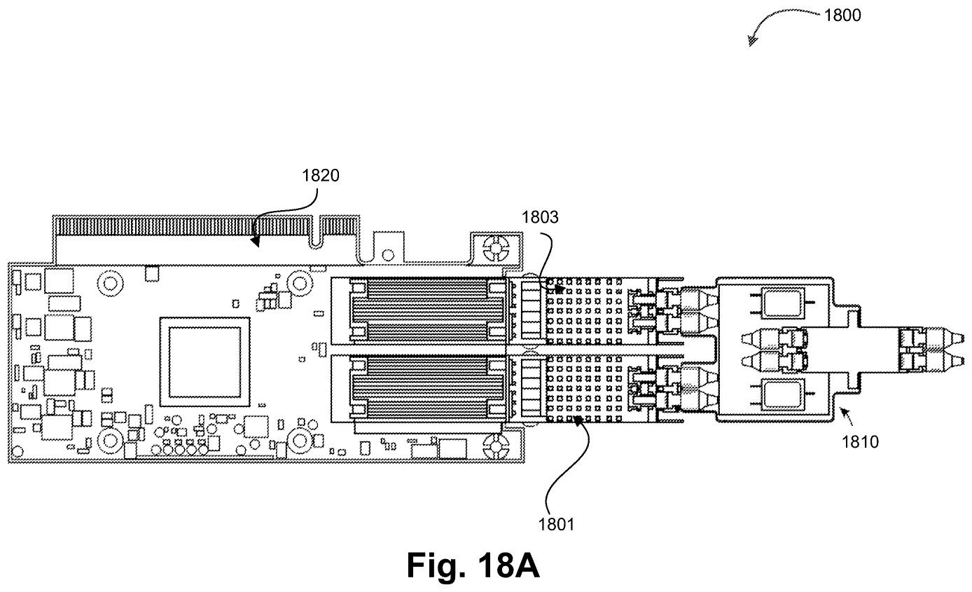

FIG. 17 illustrates a system 1700 according to one or more embodiments of the present disclosure. The system 1700 includes a network interface controller (NIC) 1702. The NIC 1702 is, for example, a hardware component (e.g., a network interface controller) configured to connect to a network and/or to facilitate communications within the network. In certain embodiments, the NIC 1702 can be included in and/or can be coupled to a network interface module such as a transceiver device (e.g., an optical transceiver) that facilitates fiber optic communication. In one or more embodiments, the NIC 1702 can be configured to manage transmission of one or more optical signals via an optical fiber. Additionally or alternatively, in one or more embodiments, the NIC 1702 can be configured to control emission of one or more optical signals via a laser.

The NIC 1702, as depicted in FIG. 17, is coupled to a communication channel 1704 and a communication channel 1706. The communication channel 1704 may be a first communication channel associated with quantum communication (e.g., a QKD-based communication). The communication channel 1706 may be a second communication channel associated with classical network communication (e.g., non-QKD-based communication). In one or more embodiments, the communication channel 1706 is an optical communication channel (e.g., a transparent fiber optical connection) that transmits data (e.g., pulses of infrared light) encoded via qubits (e.g., a quantum communication data stream). In one or more embodiments, the communication channel 1706 is an optical communication channel (e.g., a transparent fiber optical connection) that transmits data (e.g., pulses of infrared light) encoded via bits (e.g., a binary data stream). Accordingly, the NIC 1702 can be configured to interface a QKD-based communication medium and a non-QKD-based communication medium. In an embodiment, the NIC 1702 is configured to receive qubit data 1708 via the communication channel 1704. The qubit data 1708 can include, for example, qubits associated with quantum information. Furthermore, in an embodiment, the NIC 1702 is configured to output binary bit data 1710 via the communication channel 1706. The binary bit data 1710 can include, for example, one or more classical binary bits associated with binary information. In one or more embodiments, the communication channel 1704 and/or the communication channel 1706 can be bi-directional. As such, in another embodiment, the NIC 1702 is configured to output the qubit data 1708 via the communication channel 1704. Furthermore, in another embodiment, the NIC 1702 is configured to receive the binary bit data 1710 via the communication channel 1706.

### Transceiver Module

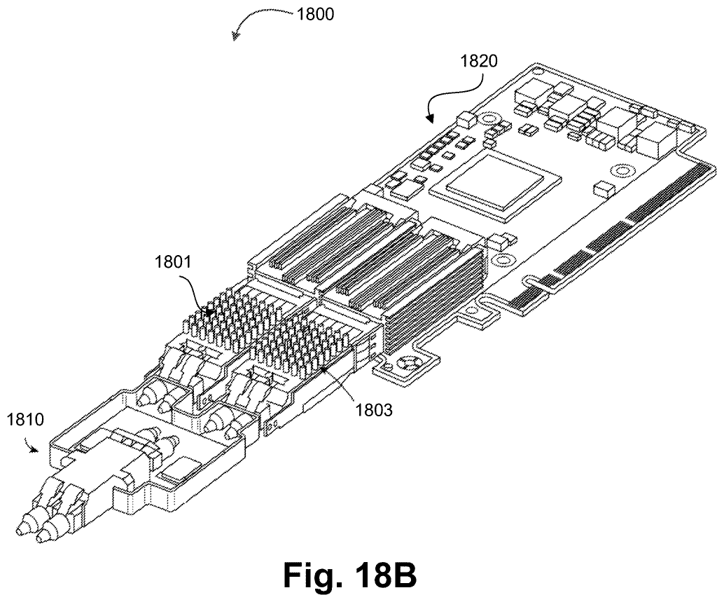

FIGS. 18A and 18B illustrate a top view and a perspective view, respectively, of a transceiver module operatively coupled to a network adapter, in the present example transceiver module 1800, in accordance with an embodiment of the disclosure. As shown in FIGS. 18A and 18B, the transceiver module may include a first optical module 1801, a second optical module 1803, an adapter 1810, and a dual-port NIC 1820 of a server. Both the first optical module 1801 and the second optical module 1803 may be dual-fiber transceivers that are configured for duplex communication that allows the source (e.g., server) to communicate with the target (e.g., leaf switch) in both directions. The adapter 1810 may be a ganged physical component configured to link the first optical module 1801 and the second optical module 1803 for the purpose of transmitting and receiving data to and from the leaf switch.

In some embodiments, the adapter 1810 may be configured to operate in two configurations, such as a first configuration and a second configuration. In one aspect, the first configuration may be a default configuration of operation, where the first optical module 1801 may be operationally active. The second configuration may be a contingent configuration that is implemented when the first optical module 1801 operationally fails. When such a failure is detected, the second optical module 1803, which is otherwise operationally inactive or idle, may be engaged become operationally active and handle all network traffic that was initially handled by the first optical module 1801.

In some embodiments, the transceiver module 1800 may be configured to operate in a leaf-spine architecture. A leaf-spine architecture is a data center network topology that may include two switching layers—a spine layer and a leaf layer. The leaf layer may include access switches (leaf switches) that aggregate traffic from servers and connect directly into the spine or network core. Spine switches interconnect all leaf switches in a full-mesh topology between access switches in the leaf layer and the servers from which the access switches aggregate traffic. As such, in one embodiment, to ensure reliable operation of downlinks, the transceiver module 1800 may be configured to operate between the server and the leaf layer. In particular, as shown in FIGS. 18A and 18B, the adapter 1810 may be operatively coupled to the first optical module 1801 and the second optical module 1803, while the first optical module 1801 and the second optical module 1803 may be operatively coupled to a dual-port NIC 1820 of a server.

In embodiments, the transceiver module 1800 may comprise one or more processing circuits, as detailed above; the processing circuits may comprise FW, that is loaded according to the techniques described above.

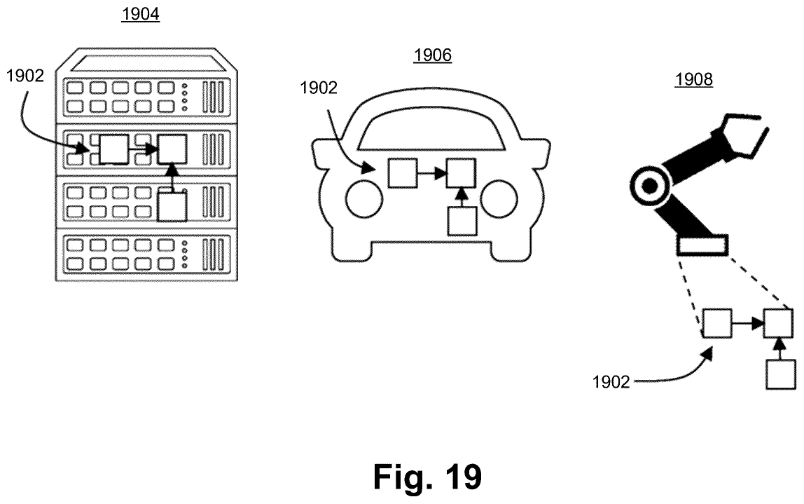

FIG. 19 depicts exemplary scenarios for use of an optical transceiver 1902 in accordance with some embodiments. An optical transceiver 1902 may be utilized in a computing system 1904 (e.g., in a server farm, or within a server computer system), a vehicle 1906 (e.g., a car, truck, train, or airplane), and a robot 1908 (or among robots in a factory), to name just a few examples. The optical transceiver 1902 may be particularly useful for high-speed communication in environments subject to high levels of electromagnetic interference (EMI).

Silicon Photonics (SiP) is a technology that enables optical systems to be manufactured using silicon processes with silicon as the optical medium. Various optical components, such as interconnects and signal processing components, may be fabricated and integrated in a single SiP device. Some SiP devices are fabricated on a silica substrate or over a silica layer on a silicon substrate, a technology that is often referred to as Silicon on Insulator (SOI). In certain optical systems, a SiP device is attached to an external device to facilitate optical communications. However, it is generally difficult to accurately align light signals on the SiP with an external device that receives the light.

In certain optical systems, a SiP device is attached to an external device to facilitate optical communications. However, it is generally difficult to accurately align light signals on the SiP with an external device that receives the light. For instance, long range transmission of light signals is generally performed within optical fibers. When optical signals are generated or processed in a SiP device for transmission over optical fibers, the light needs to be coupled between the SiP device and the optical fibers. This coupling between the SiP device and the optical fibers is generally difficult because waveguides within the SiP device generally comprise a smaller diameter than the optical fibers. As such, a “world-to-chip” interface problem often arises in SiP technologies where coupling of light between Si wire waveguides and optical fibers, and vice versa, is generally inefficient.

Traditionally, for fiber-to-chip coupling, a fiber coupling technique using spot-size converters (SSCs) or grating couplers is employed. However, grating couplers for fiber-to-chip coupling typically provide a narrow bandwidth and/or an undesirable polarization sensitivity for certain optical applications. Furthermore, SSCs and grating couplers for fiber-to-chip coupling are generally attached to the chip through an adhesive bonding technique that results in a silicon communication chip with bundles of fibers attached thereto, resulting in increased complexity for handling and/or assembly of the chips onto other optical systems. Additionally, wafers for traditional SiP devices are generally diced (e.g., fully cut through) to create an edge for the wafer to expose waveguide facets and/or to facilitate butt attachment of the SiP device to an external device.

### Optical Switch

High-capacity optical switch assemblies switch multiple channels of data at high data rates, with the number of channels reaching several hundreds and data rates reaching hundreds of Gb/s (Gb/s=10⁹ bits per second). In order to save power, it is desirable to co-package the switch itself with “optical engines,” which typically are small, high-density optical transceivers located within an application-specific integrated circuit (ASIC) or within an ASIC package together with the switch.

The switch assembly is contained in a rack-mounted case, with optical receptacles on its front panel for ease of access. The signals from and to the ASIC are conveyed to and from the optical receptacles using optical fibers.

To further simplify installation and use, it is sometimes desirable that the optical cable be detachable from the transceivers so that a smaller cable may be routed through an installation. Each optical cable may, instead of comprising a transceiver, be designed to mate with a particular transceiver. The transceiver may be connected to a node, such as a server, and be used to connect a connector of each cable to the node as described herein.

In embodiments, the optical switch assembly may comprise one or more processing circuits; the processing circuits may comprise firmware that is loaded according to the techniques described above.

Optical switches are one solution for enabling advances in networking due to the technology's potential for very high data capacity and low power consumption. Optical switches feature optical input and output ports and are capable of routing light that is coupled to the input ports to the intended output ports on demand, according to one or more control signals (electrical or optical control signals). Routing of the signals is performed in the optical domain, i.e. without the need for optical-electrical and electrical-optical conversion, thus bypassing the need for power-consuming transceivers. Header processing and buffering of the data is not possible in the optical domain and thus, packet switching (as it is realized in electrical switches) cannot be employed. Instead, the circuit switching paradigm is used: an end-to-end circuit is created for the communication between two endpoints connected on the input and the output of the optical switch. Director switches may be used in the most common datacenter interconnection topologies, e.g., fat trees, Slim Fly, and Dragonfly+). In addition, inventive concepts propose to place such hybrid switching systems “in the middle” of the network (e.g., replacing the edge/top of rack (TOR) layer and aggregation layer).

An optical switch may include hardware and/or software for routing signals in the optical domain. Thus, in one embodiment, an optical switch may include input optical fibers and output optical fibers that carry optical signals as well as one or more devices suited for routing optical signals within the optical switch. For example, the one or more devices for routing optical signals may include one or more movable mirrors (e.g., MEMS mirrors) that are controlled to move in a manner that directs light from an input fiber to a desired output fiber or to move in a manner that forces or guides light from one waveguide into another waveguide. An optical switch may include one or more devices for amplifying light in order to compensate for propagation and scattering losses introduced by the optical switch. In at least one example embodiment, signals input and output to an ASIC are optical, meaning that each optical switch connected to an electrical switch routes optical signals received from the electrical switch without using hardware and/or software that converts an electrical signal into an optical signal for routing within the optical switch. However, example embodiments are not limited thereto, and an optical switch may include electrical to optical to electrical conversion hardware and/or software if desired (e.g., if the input signal and/or output signal is an electrical signal).

The optical switch(es) may include an arrayed waveguide grating router (AWGR), which is a passive switch fabric. In some embodiments, the optical switch(es) may correspond to a passive element that operates as a wavelength router that uses multiple wavelengths to interconnect outputs and inputs by following a specific cyclic wavelength routing pattern.

An optical switch, on the other hand, may function by directly routing optical signals without converting them to electrical signals. Each optical switch may include optical receivers, such as photodetectors and wavelength-division multiplexing (WDM) demultiplexers, that receive incoming optical signals. These optical signals may then be directed through internal optical switching components, such as micro-electromechanical systems (MEMS) mirrors, waveguides, or optical cross-connects, which route the signals to the appropriate output paths. The optical switch may also include optical transmitters, such as laser diodes and modulators, which transmit the routed optical signals to the next switch in the network. A hybrid electro-optical switch may combine both electrical and optical components to route signals. Such a switch may include receivers that convert optical signals into electrical signals using TIAs and photodetectors, similar to those in electrical switches. These electrical signals can then be routed within the switch using internal electrical switching circuitry. Additionally, the hybrid switch may contain optical switching components, such as WDM multiplexers and MEMS devices, to route optical signals directly. The transmitters in a hybrid switch may include both electrical-to-optical converters and direct optical transmitters, enabling the hybrid switch to interface with both electrical and optical networks. For example, a hybrid switch's transmitter may include a light source, a modulator for optical signals, and traditional electrical signal transmitters, providing routing capabilities across different signal domains.

The interconnections between the switches within the network topology may be implemented via optical fibers or traditional electrical cables, depending on the specific requirements of the system. For instance, the communication lanes may be constructed of dedicated differential cable pairs and/or fiber optics, each tailored to provide optimal performance for the data transmission needs. The dedicated differential cable pairs used in these interconnections may include a variety of cable media such as copper, aluminum, gold, silver, nickel, or composite materials like copper-clad aluminum, copper-clad steel, or bimetallic conductors. These materials may be chosen for their electrical conductivity and durability, ensuring reliable and efficient data transmission. For example, in a four-lane network, each lane may consist of its own dedicated copper cable, providing isolated physical paths for each communication lane of a deserialized data stream. This configuration helps in maintaining signal integrity and reducing crosstalk between lanes.

Alternatively, fiber optic cables may be employed for the interconnections. Fiber optics are capable of transmitting data streams via different wavelengths of light, with each data stream assigned a unique wavelength. The use of fiber optic cables may allow multiple data streams to be transmitted simultaneously through a single fiber optic cable, significantly increasing the bandwidth and efficiency of the network, and particularly advantageous for long-distance data transmission and for applications requiring high data transfer rates. Various optical networking technologies can be used to transmit multiple optical signals (e.g., data signals or data streams) over a single optical fiber within an optical link with little to no optical signal interference. These technologies may be used to improve bandwidth efficiency and reduce the amount of infrastructure needed for data communication.

One such technology is Time Division Multiplexing (TDM). In TDM, multiple optical signals can be transmitted over a single optical fiber by assigning each optical signal a respective time slot and transmitting an optical signal during its assigned time slot. The time slots are allocated in a cyclic manner, with each optical signal transmitting a small amount of data during its assigned time slot. The time slots are very short, on the order of microseconds, and the cycle repeats many times per second, allowing for rapid data transfer.

Another technology is Frequency Division Multiplexing (FDM). In FDM, multiple optical signals can be transmitted over a single optical fiber by assigning each optical signal a respective frequency band. Each optical signal is modulated onto a respective carrier frequency to generate a modulated signal, and these modulated signals are combined and transmitted over a single optical fiber. At the receiver, the modulated signals are separated using filters (e.g., band-pass filters) that permit optical signals meeting specific frequency specifications to pass through while filtering out other signals. FDM allows optical links to simultaneously transmit multiple channels over the same frequency band.

Yet another technology is Wavelength Division Multiplexing (WDM). In WDM, multiple optical signals having different wavelengths are combined into a single optical signal and transmitted over a single optical fiber. WDM techniques involve combining and separating multiple optical signals with different wavelengths onto a single optical fiber, allowing for more data to be transmitted and increasing the capacity of the optical fiber.

Examples of WDM technology include Coarse Wavelength Division Multiplexing (CWDM) and Dense Wavelength Division Multiplexing (DWDM). CWDM combines multiple optical signals at different wavelengths into a single optical signal and transmits it over a single optical fiber. CWDM uses a wider wavelength separation, such as about 80 nanometers (nm), which means it supports fewer channels and has lower power budgets, making it suitable for shorter distances, up to about 80 kilometers (km). CWDM requires less complex equipment and lower-cost optical components, making it a cost-effective solution for applications that do not require dense wavelength separation. In contrast, DWDM uses narrower wavelength separation, such as about 0.8 nm, allowing for higher channel capacity and longer distances, but typically at a higher cost and complexity.

### Optical Switch Assemblies

High-capacity optical switch assemblies switch multiple channels of data at high data rates, with the number of channels reaching several hundreds and data rates reaching hundreds of Gb/s (Gb/s=10⁹ bits per second). In order to save power, it is desirable to co-package the switch itself with “optical engines,” which typically are small, high-density optical transceivers located within an application-specific integrated circuit (ASIC) or within an ASIC package together with the switch.

The switch assembly is contained in a rack-mounted case, with optical receptacles on its front panel for ease of access. The signals from and to the ASIC are conveyed to and from the optical receptacles using optical fibers.

Space constraints of the switch and the front panel limit the number of optical fibers connected to the ASIC and optical receptacles on the panel. Therefore, the optical signals emitted and received by the switch are multiplexed using wavelength-division multiplexing, so that each fiber, along with the associated optical receptacle, carries multiple optical signals. For example, each fiber may carry four channels of 100 Gb/s each, at four different, respective wavelengths, to and from the corresponding optical receptacle, for a total data rate of 400 Gb/s (denoted as 4×100 Gb/s).

In many cases, the multiple communication channels carried at different wavelengths on the same fiber are directed to and from different network nodes. For example, each of the 100 Gb/s component signals on a 4×100 Gb/s optical link may be directed to a different server. Therefore, there is a need for an optical cable that is capable of splitting the multiplexed optical signal into multiple component signals at different, respective wavelengths, and be capable of conveying each of these signals to a different network node. For simplicity of installation and use, it is desirable that the optical cable be “active,” meaning that transceivers in the cable convert each of the multiple optical signals to a standard electrical form (and vice versa). As a result, the network nodes need process only electrical signals and will be indifferent to the actual wavelength of the optical channel that is directed to each of them.

### Example System Use-Cases

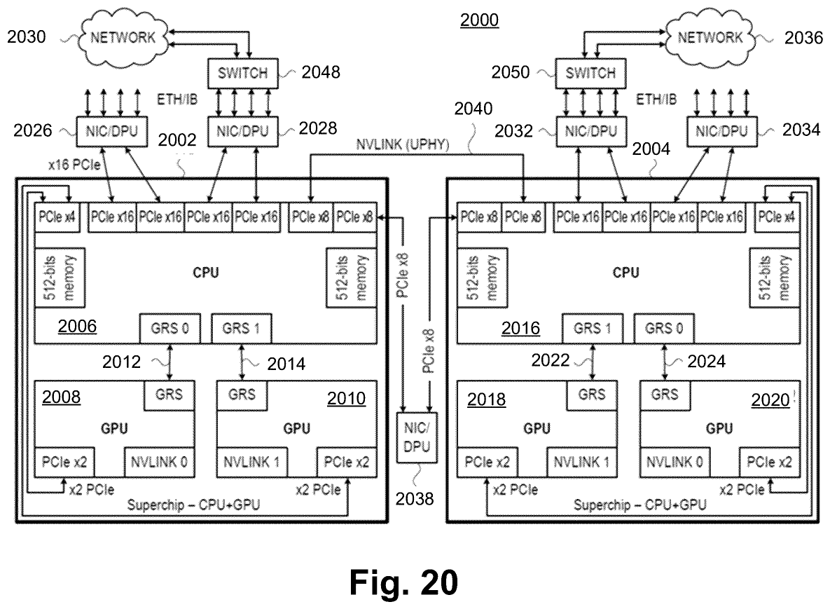

FIG. 20 is a block diagram that schematically illustrates a computing system 2000, e.g., a data center or a High-Performance Computing (HPC) cluster, in accordance with an embodiment that is described herein. System 2000 comprises a plurality of subsystems, e.g. multiple processing devices coupled to each other, multiple network devices, and multiple networks, according to at least one embodiment. Computing system 2000 is designed with multiple integrated circuits (referred to as processing devices), where each integrated circuit can include one or more CPUs and GPUs, forming a powerful and flexible architecture.

The various processing devices are interconnected via an NVLink or other high-speed interconnect, enabling high-speed communication between the subsystems, and are also connected through a NIC or DPU to ensure efficient data transfer across computing system 2000 and to one or more external networks 2030, 2036. In the present example, system 2000 comprises a packet switch 2048 that connects NIC/DPU 2028 to network 2030, and a packet switch 2050 that connects NIC/DPU 2032 to network 2036.

The coupling of processing devices through NVLink allows for seamless data exchange and parallel processing, enhancing overall computational performance. The processing devices are connected to multiple networks through one or more network interface controllers (NICs) or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 2000 can include one or more CPUs and one or more GPUs.

FIG. 20 also demonstrates an example architecture of a multi-GPU architecture. As illustrated in the figure, computing system 2000 includes a processing device 2002 with a multi-GPU architecture. In particular, processing device 2002 may be a system-on-chip and includes multiple subsystems such as a CPU 2006, a GPU 2008, and a GPU 2010. CPU 2006 can be coupled to GPU 2008 via a die-to-die (D2D) or chip-to-chip (C2C) interconnect 2012, such as a Ground-Referenced Signaling interconnect (GRS interconnect). CPU 2006 can be coupled to GPU 2010 via a D2D or C2C interconnect 2014. CPU 2006 can also couple to GPU 2008 and GPU 2010 via PCIe interconnects.

CPU 2006 can be coupled to one or more NICs or DPUs, which are coupled to one or more networks. For example, as illustrated in FIG. 20, CPU 2006 is coupled to a first NIC/DPU 2026, which is coupled to a network 2030. CPU 2006 is also coupled to a second NIC/DPU 2028, which is coupled to network 2030 via switch 2048. NIC/DPU 2026 and NIC/DPU 2028 can be coupled to network 2030 over Ethernet (ETH), NVLINK or InfiniBand (IB) connections, for example.

Computing system 2000 also includes a processing device 2004 with a multi-GPU architecture. In particular, processing device 2004 includes multiple subsystems including a CPU 2016, a GPU 2018, and a GPU 2020. CPU 2016 can be coupled to GPU 2018 via an D2D or C2C interconnect 2022. CPU 2016 can be coupled to GPU 2020 via a D2D or C2C interconnect 2024. CPU 2016 can also couple to GPU 2018 and GPU 2020 via PCIe interconnects. CPU 2016 can be coupled to one or more NICs or DPUs, which are coupled to one or more networks. For example, as illustrated in FIG. 20, CPU 2016 is coupled to a first NIC/DPU 2032, which is coupled to a network 2036. CPU 2016 is also coupled to a second NIC/DPU 2034, which is coupled to network 2036 via switch 2050. NIC/DPU 2032 and NIC/DPU 2034 can be coupled to network 2036 over Ethernet (ETH), NVLINK or InfiniBand (IB) connections.

In at least one embodiment, processing device 2002 and processing device 2004 can communication with each other via a NIC/DPU 2038, such as over PCIe interconnects. Processing device 2002 and processing device 2004 can also communicate with each other over a high-bandwidth communication interconnects 2040, such as an NVLink interconnect or other high-speed interconnects. The packet switches in FIG. 20 may comprise, for example, Nvidia Quantum-2 switches. The NICs/DPUs in the figure may comprise, for example, Nvidia Bluefield DPUs.

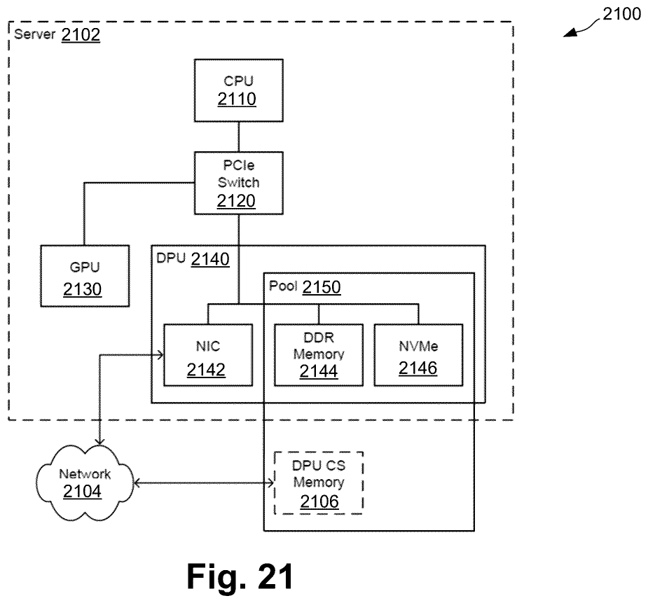

FIG. 21 illustrates an example computing environment, in accordance with at least one embodiment. FIG. 21 illustrates an example computing environment 2100 in which forward pass offloading to available memory can be performed, in accordance with at least one embodiment. It should be appreciated that embodiments of the present disclosure may also be used with reference to alternative environments and that specific discussion of components may be provided by way of non-limiting example and may include equivalents. Moreover, various features have been removed for clarity and conciseness. Additionally, systems and methods may be used with a variety of different architectures. The example computing environment 2100 may include a server 2102 which may be used to perform HPC workloads, such as AI training or machine learning model training. In an embodiment, the server 2102 may be an application instance or a compute node. The server 2102 may include a CPU 2110 associated with a switch 2120, such as a peripheral component interconnect express (PCIe) switch, which may control at least some data transmission over communication paths interconnecting various components. In an embodiment, the CPU 2110 may include a root complex processor.

The PCIe switch 2120 may also be associated with a GPU 2130 and a DPU 2140 and may transmit data between at least some of the CPU 2110, the GPU 2130, the DPU 2140, and other components. In an embodiment, the PCIe switch 2120 may be associated with more than one GPU or more than one DPU. In another embodiment, the PCIe switch 2120 may be located within the DPU 2140. The PCIe switch 2120 may manage the transfer of at least some data between the CPU 2110, the GPU 2130, and the DPU 2140. In another embodiment, the number of GPUs associated with the PCIe switch 2120 may be equal to the number of DPUs associated with the PCIe switch 2120. In at least one embodiment, the server 2102 may include, without limitation, any number of the CPUs 2110, the PCIe switches 2120, the GPUs 2130, and/or the DPUs 2140, in any combination. For example, in at least one embodiment, server 2102 could include eight, sixteen, thirty-two, and/or more GPUs 2130. In at least one embodiment, communication paths interconnecting various components, including but not limited to the CPU 2110, the PCIe switch 2120, the GPU 2130, and the DPU 2140, in FIG. 21 may be implemented using any suitable protocols, such as peripheral component interconnect (PCI) based protocols (e.g., PCIe), or other bus or point-to-point communication interfaces and/or protocol(s), such as NV-Link high-speed interconnect, or interconnect protocols.

The DPU 2140 may include a network interface controller (NIC) 2142, a DDR memory 2144, and a non-volatile memory express (NVMe) device 2146. The NIC 2142 may be able to interface with a network 2104, which may also interface with additional NVMe devices available to the DPU 2140, such as over fabric. In an embodiment, the DPU 2140 may not include the NVMe device 2146. In another embodiment, the NVMe device 2146 may be located on the server 2102 and not on the DPU 2140. In yet another embodiment, the computing environment 2100 may include more than one of the NVMe device 2146, such as a first NVMe device in the DPU 2140 and a second first NVMe device on the server 2102 an associated directly with the PCIe switch 2120. In an embodiment, the DPU 2140 may not include the DDR memory 2144 and may include a computational storage service (CSS) in place of, or in addition to, the DDR memory 2144. For example, computing environment 2100 may include DPU computational storage (CS) memory 2106 available to the DPU 2140 as part of the CSS. The network 2104 may be able to interface with the DPU CS memory 2106 through the NIC 2142, according to any suitable interface protocol, such as remote direct memory access (RDMA) over Ethernet, InfiniBand, Fiber Channel, etc.

The total memory of the computing environment 2100 available for data storage may be expanded through the use of the DPU 2140 on nodes of the system. The DPU 2140 may have access to a pool 2150 of memory already available to the server 2102, such as double data rate (DDR) memory, on-board NVMe devices, NVMe devices over fabric, and CS. The pool 2150 of memory may include at least one of the DDR memory 2144, NVMe 2146, and the DPU CS memory 2106. The DPU 2140 may also be able to access the available memory of other DPUs as part of the pool 2150, and other DPUs may be able to access the available memory of DPU 2140, such as the pool 2150. This available memory can be accessed and utilized for data storage, without the addition of compute resources, such as compute nodes, which would be required using other solutions. The available pool 2150 accessible to the DPU 2140 may be provisioned for the server 2102 to expand the total memory available for data storage, such as to reduce the data storage load on the CPU 2110 or the GPU 2130, which can instead increase the utilization of their memory for processing. For example, during training of an AI, the model states, residual states, activation functions, and checkpoints can be stored, or offloaded, on the pool 2150 accessible to the DPU 2140.

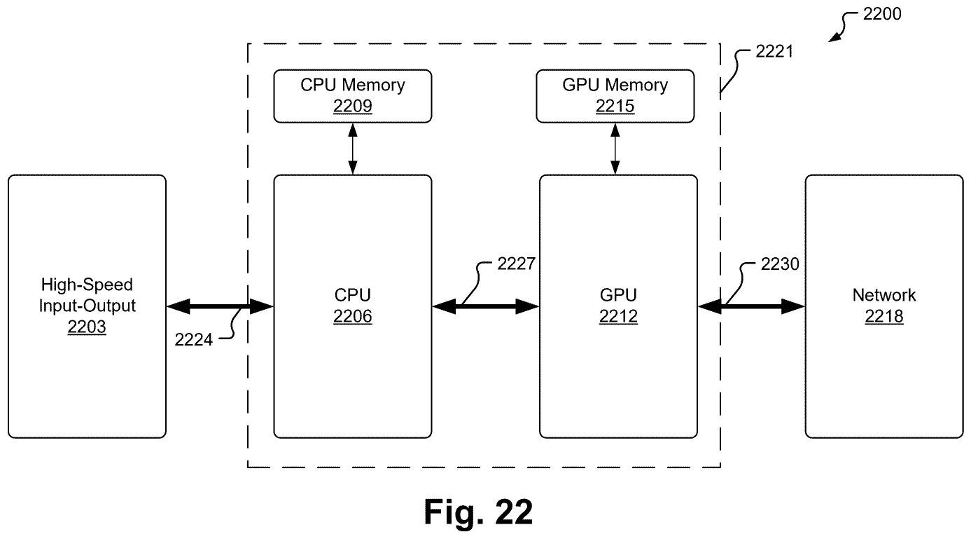

FIG. 22 is a block diagram that schematically illustrates a computing system 2200, e.g., a data center or a High-Performance Computing (HPC) cluster, in accordance with an embodiment that is described herein, including at least a first processing device 2221. The computing system 2200 also includes a network 2218 which may include a network of GPUs, such as an NVLink network including up to 256 GPUs.

The processing device 2221 may include a CPU 2206, a GPU 2212, CPU memory 2209, and GPU memory 2215. The CPU 2206 and the GPU 2212 of the processing device 2221 may communicate via one or more interconnects 2227 such as an NVLink or other highspeed interconnect. The CPU memory 2209 may be low-power double data rate (LPDDR) 10X memory or another memory type. The GPU memory 2215 may be high bandwidth memory (HBM), HBM3, or HBM3e memory, or another memory type.

The processing device 2221 may be in communication with a high-speed input-output (IO) 2203 via one or more PCIe or other high-speed interconnects 2224. In one example, the CPU 2206 of the processing device 2221 is connected to the high-speed IO 2203 via four 16× PCIe-10 connections. In at least one embodiment, the high-speed IO 2203 is a NIC/DPU and enables connection with the processing device 2221, such as over PCIe interconnects 2224.

The network 2218 may include a number of processing devices and may be coupled to the processing device 2221 via one or more interconnects 2230. In an example, the processing device 2221 is connected to the network 2281 via eighteen NVLink 9 interconnects 2230. The coupling of processing devices through NVLink allows for seamless data exchange and parallel processing, enhancing overall computational performance. The processing devices are connected to multiple networks through one or more NICs or DPUs, enabling the system to handle complex, multi-network tasks with high bandwidth and low latency. This configuration is highly suitable for demanding applications that require significant processing power, such as AI, ML, and data-intensive computing, while ensuring robust connectivity and scalability across various networked environments. The integrated circuits of the computing system 2200 can include one or more CPUs and one or more GPUs.

In some implementations, threads of a GPU 2212 of a first processing device 2221 may be enabled to access GPU memory 2215 and/or CPU memory 2209 of one or more peer processing devices 2221 in the network 2218, such as via an NVLink page table. As an example, CUDA APIs may allow applications to map memory from remote nodes into a current process and then perform load, stores, atomics, and/or bulk memory transfers to directly access the memory. Communication between the processing device 2221 and devices in the network 2218 may be implemented using one or more of the QKD transceivers as described above.

### System Overview

The systems and methods described herein may be implemented across a range of data center and high-performance computing environments. In some embodiments, components may include one or more optical transceivers, photonic integrated circuits (PICs), electronic processors, memory units, and programmable logic (e.g., FPGAs or ASICs).

The system architecture may include a layered protocol stack enabling optical interconnects between compute nodes, GPUs, or switch fabrics. Although described in the context of optical signaling (e.g., PAM4 modulation over silicon photonics), the methods may be adapted for use in electrical signaling environments or hybrid opto-electrical systems.

### Hardware/Software Flexibility

Aspects of the disclosed technology may be implemented in hardware, software, firmware, or combinations thereof. For example, a congestion-aware routing module may be realized as a hardware IP block, or as software instructions executing on a network controller.

The system may include machine-readable instructions stored in non-transitory memory that, when executed, cause the system to perform steps such as: dynamic wavelength assignment, error correction encoding, channel bonding, or adaptive modulation format selection.

### Modularity & Scalability

In some implementations, system components may be distributed across multiple dies or chiplets interconnected via high-speed SerDes lanes, optical waveguides, or interposer-based photonic links. Embodiments may support scaling from single-link configurations to mesh, torus, or custom topologies based on application workload requirements.

The term “automatic” and variations thereof, as used herein, refers to any appropriate process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The terms “determine,” “calculate,” “compute,” and variations thereof, as used herein, are used interchangeably, and include any appropriate type of methodology, process, operation, or technique.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

Use of terms “a,” “an,” “the,” and similar referents in context of describing disclosed embodiments (as well as in the context of the following claims) are to be construed to cover both singular and plural, unless otherwise indicated herein or clearly contradicted by context, and not as a definition of a term. The term “and/or” is to be construed as including any and all combinations of one or more of the associated listed items. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into the specification as if it were individually recited herein. In at least one embodiment, use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in an illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

In description and claims, terms “coupled” and “connected,” along with their derivatives, may be used. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or the like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In the present document, references may be made to obtaining, acquiring, receiving, or inputting analog or digital data into a subsystem, computer system, or computer-implemented machine. In at least one embodiment, the process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or inter-process communication mechanism.

Although descriptions herein set forth example implementations of described techniques, other architectures may be used to implement described functionality and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. An apparatus, comprising a quantum key distribution (QKD) link between a first connector and a second connector enabling a multipoint QKDs transmission between a first device connected to the first connector via a first link and a second device connected to the second connector via a second link.

2. An apparatus, comprising a multipoint QKD link,
the apparatus configured to provide a QKD communication channel between two devices, wherein each device is connected to the apparatus via a respective link.

3. An apparatus, comprising:
a first circuit to receive a first optical signal including at least a first one or more encoded photons;
a quantum key distribution (QKD) transmitter to generate a second optical signal including at least a second one or more encoded photons;
a multiplexer circuit to multiplex the first optical signal with the second optical signal and to output a multiplexed optical signal including at least the first one or more encoded photons and the second one or more encoded photons; and
a second circuit to transmit the multiplexed optical signal onto a fiber link including at least the first one or more encoded photons and the second one or more encoded photons.

4. The apparatus of claim 3, further comprising:
a tunable de-multiplexer circuit to process the first optical signal and selectively output a third one or more encoded photons from the first optical signal; and
a QKD receiver to receive the third one or more encoded photons.

5. The apparatus of claim 4, wherein the tunable de-multiplexer circuit chromatically separates a third optical signal from the first optical signal based on a wavelength of the third optical signal, wherein the third optical signal includes a third one or more encoded photons.

6. The apparatus of claim 3, wherein the first optical signal includes the first one or more encoded photons at a first wavelength and a third one or more encoded photons at a second wavelength.

7. The apparatus of claim 3, wherein the multiplexer circuit is tunable, and multiplexes a plurality of optical signals of different wavelengths with the first optical signal.

8. The apparatus of claim 3, wherein the QKD transmitter generates a plurality of sets of one or more encoded photons and outputs each set of one or more encoded photons at a different wavelength.

9. The apparatus of claim 3, wherein the apparatus forms a uni-directional QKD link.

10. The apparatus of claim 3, wherein the apparatus forms a bi-directional QKD link.

11. The apparatus of claim 3, wherein the first circuit and the second circuit each comprise a fiber connection circuit.

12. The apparatus of claim 3, wherein the apparatus is one of a mid-board optical module (MBOM), a linear pluggable optics (LPO) transceiver, a quad small form-factor pluggable (QSFP) transceiver, a quad small form-factor pluggable double density (QSFP-DD) transceiver.

13. The apparatus of claim 3, wherein the apparatus is an optical switch.

14. The apparatus of claim 3, wherein the first circuit, the QKD transmitter, the multiplexer circuit, and the second circuit are contained within a co-packaged optics (CPO) package.

15. The apparatus of claim 3, wherein the apparatus further comprises optical and electronic components integrated in an integrated circuit.

16. The apparatus of claim 3, wherein the first and second circuits each comprise a dedicated fiber link.

17. The apparatus of claim 3, wherein the apparatus establishes a QKD link between the apparatus and a plurality of nodes.

18. The apparatus of claim 3, wherein the apparatus establishes a QKD link between a first plurality of nodes and a second plurality of nodes.

19. The apparatus of claim 3, wherein the first one or more encoded photons are received from a first device via a first optical fiber link and are transmitted to a second device via a second optical fiber link, wherein the first device and the second device establish a QKD link using the one or more encoded photons.

20. The apparatus of claim 19, wherein the second one or more encoded photons are transmitted to the second device via a second optical fiber link, wherein the apparatus and a third device establish a QKD link using the one or more encoded photons.
